(19) United States
(12) Patent Application Publication
(10) Pub. No.: US 2015/0332682 A1
(43) Pub. Date: Nov. 19, 2015

(54) SPATIAL RELATION CODING FOR HIGHER ORDER AMBISONIC COEFFICIENTS

(71) Applicant: QUALCOMM Incorporated, San Diego, CA (US)

(72) Inventors: Moo Young Kim, San Diego, CA (US); Jeongook Song, San Diego, CA (US)

(21) Appl. No.: 14/712,799

(22) Filed: May 14, 2015

Related U.S. Application Data
(60) Provisional application No. 61/994,542, filed on May 16, 2014.
(60) Provisional application No. 61/994,855, filed on May 17, 2014.
(60) Provisional application No. 62/004,155, filed on May 28, 2014.

(51) Int. Cl. G10L 19/008

(52) U.S. Cl. CPC G10L 19/008

(57) ABSTRACT

A device for decoding audio data comprises a memory to store the audio data; and one or more processors coupled to the memory and configured to obtain spatial information for a spatial relation of non-zero order higher-order ambisonic (HOA) coefficients associated with a spherical basis function having an order greater than zero, with zero-order HOA coefficients associated with a spherical basis function having an order of zero, the spatial information resulting in an error between the non-zero order HOA coefficients and a signal model of the non-zero order HOA coefficients that represents at least one directional component of the non-zero order HOA coefficients in the spatial relation with the zero-order HOA coefficients, wherein the one or more processors are further configured to obtain sign information for the non-zero order HOA coefficients when reconstructing the non-zero order HOA coefficients using the spatial relation.

This application claims the benefit of U.S. Provisional Application No. 61/994,542, filed May 16, 2014; U.S. Provisional Application No. 61/994,855, filed May 17, 2014; and U.S. Provisional Application No. 62/004,155, filed May 28, 2014, the entire contents of each being incorporated by reference herein.

### TECHNICAL FIELD

This disclosure relates to audio data and, more specifically, coding of higher-order ambisonic audio data.

### BACKGROUND

A higher-order ambisonics (HOA) signal (often represented by a plurality of spherical harmonic coefficients (SHC) or other hierarchical elements) is a three-dimensional representation of a soundfield. The HOA or SHC representation may represent the soundfield in a manner that is independent of the local speaker geometry used to playback a multi-channel audio signal rendered from the SHC signal. The SHC signal may also facilitate backwards compatibility as the SHC signal may be rendered to well-known and highly adopted multi-channel formats, such as a 5.1 audio channel format or a 7.1 audio channel format. The SHC representation may therefore enable a better representation of a soundfield that also accommodates backward compatibility.

### SUMMARY

In general, techniques are described for coding of higher-order ambisonics audio data. Higher-order ambisonics audio data may comprise at least one higher-order ambisonic (HOA) coefficient corresponding to a spherical harmonic basis function having an order greater than one. In some aspects, the techniques include increasing a compression rate of quantized spherical harmonic coefficients (SHC) signals by encoding directional components of the signals according to a spatial relation (e.g., Theta/Phi) with the zero-order SHC channel, where Theta or θ indicates an angle of azimuth and Phi or Φ/φ indicates an angle of elevation. In some aspects, the techniques include employing a sign-based signaling synthesis model to reduce artifacts introduced due to frame boundaries that may cause such sign changes.

In one aspect, a device for decoding audio data comprises a memory to store the audio data; and one or more processors coupled to the memory and configured to obtain spatial information for a spatial relation of non-zero order higher-order ambisonic (HOA) coefficients associated with a spherical basis function having an order greater than zero, with zero-order HOA coefficients associated with a spherical basis function having an order of zero, the spatial information resulting in an error between the non-zero order HOA coefficients and a signal model of the non-zero order HOA coefficients that represents at least one directional component of the non-zero order HOA coefficients in the spatial relation with the zero-order HOA coefficients, wherein the one or more processors are further configured to obtain sign information for the non-zero order HOA coefficients when reconstructing the non-zero order HOA coefficients using the spatial relation.

In another aspect, a method of encoding audio data comprises obtaining spatial information for a spatial relation of non-zero order higher-order ambisonic (HOA) coefficients associated with a spherical basis function having an order greater than zero, with zero-order HOA coefficients associated with a spherical basis function having an order of zero, the spatial information resulting in an error between the non-zero order HOA coefficients and a signal model of the non-zero order HOA coefficients that represents at least one directional component of the non-zero order HOA coefficients in the spatial relation with the zero-order HOA coefficients; and obtaining sign information for the non-zero order HOA coefficients when reconstructing the non-zero order HOA coefficients using the spatial relation.

In another aspect, a device for decoding audio data comprises a memory to store the audio data; and one or more processors coupled to the memory and configured to obtain spatial information including an elevation angle and an azimuth angle for a spatial relation of one of a first plurality of hierarchical elements comprising at least one of an X signal, a Y signal, and a Z signal and associated with a basis function having an order greater than zero, with a second plurality of hierarchical elements comprising a W signal and associated with a basis function having a zero order, the spatial information resulting in an error between the first plurality of hierarchical elements and a signal model of the first plurality of hierarchical elements that represents at least one directional component of the first plurality of hierarchical elements in the spatial relation with the second plurality of hierarchical elements.

In another aspect, a method of encoding audio data comprises obtaining spatial information including an elevation angle and an azimuth angle for a spatial relation of one of a first plurality of hierarchical elements comprising at least one of an X signal, a Y signal, and a Z signal and associated with a basis function having an order greater than zero, with a second plurality of hierarchical elements comprising a W signal and associated with a basis function having a zero order, the spatial information resulting in an error between the first plurality of hierarchical elements and a signal model of the first plurality of hierarchical elements that represents at least one directional component of the first plurality of hierarchical elements in the spatial relation with the second plurality of hierarchical elements.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a diagram illustrating spherical harmonic basis functions of various orders and sub-orders.

FIG. 2 is a diagram illustrating a system that may perform various aspects of the techniques described in this disclosure.

FIGS. 3A-3B are block diagrams each illustrating, in more detail, one example of the audio encoding device shown in the example of FIG. 2 that may perform various aspects of the techniques described in this disclosure.

FIGS. 4A-4B are block diagrams each illustrating an example of the audio decoding device of FIG. 2 in more detail.

FIG. 5A is a flowchart illustrating exemplary operation of an audio encoding device in performing various aspects of the techniques described in this disclosure.

FIG. 5B is a flowchart illustrating exemplary operation of an audio encoding device in performing various aspects of the coding techniques described in this disclosure.

FIG. 6A is a flowchart illustrating exemplary operation of an audio decoding device in performing various aspects of the techniques described in this disclosure.

FIG. 6B is a flowchart illustrating exemplary operation of an audio decoding device in performing various aspects of the coding techniques described in this disclosure.

FIG. 7 is a block diagram illustrating example components for performing techniques according to this disclosure.

FIGS. 8-9 depict visualizations for example W, X, Y, and Z signal input spectrograms and spatial information generated according to techniques described in this disclosure.

FIG. 10 is a conceptual diagram illustrating theta/phi encoding and decoding with the sign information aspects of the techniques described in this disclosure.

Like reference characters denote like elements throughout the figures and text.

### DETAILED DESCRIPTION

The evolution of surround sound has made available many output formats for entertainment nowadays. Examples of such consumer surround sound formats are mostly ‘channel’ based in that they implicitly specify feeds to loudspeakers in certain geometrical coordinates. The consumer surround sound formats include the popular 5.1 format (which includes the following six channels: front left (FL), front right (FR), center or front center, back left or surround left, back right or surround right, and low frequency effects (LFE)), the growing 7.1 format, various formats that includes height speakers such as the 7.1.4 format and the 22.2 format (e.g., for use with the Ultra High Definition Television standard). Non-consumer formats can span any number of speakers (in symmetric and non-symmetric geometries) often termed ‘surround arrays’. One example of such an array includes 32 loudspeakers positioned on coordinates on the corners of a truncated icosahedron.

The input to a future MPEG encoder is optionally one of three possible formats: (i) traditional channel-based audio (as discussed above), which is meant to be played through loudspeakers at pre-specified positions; (ii) object-based audio, which involves discrete pulse-code-modulation (PCM) data for single audio objects with associated metadata containing their location coordinates (amongst other information); and (iii) scene-based audio, which involves representing the soundfield using coefficients of spherical harmonic basis functions (also called “spherical harmonic coefficients” or SHC, “Higher-order Ambisonics” or HOA, and “HOA coefficients”). The future MPEG encoder may be described in more detail in a document entitled “Call for Proposals for 3D Audio,” by the International Organization for Standardization/International Electrotechnical Commission (ISO)/(IEC) JTC1/SC29/WG11/N13411, released January 2013 in Geneva, Switzerland, and available at http://mpeg.chiariglione.org/sites/default/files/files/standards/parts/docs/w13411.zip.

There are various ‘surround-sound’ channel-based formats in the market. They range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce the soundtrack for a movie once, and not spend effort to remix it for each speaker configuration. Recently, Standards Developing Organizations have been considering ways in which to provide an encoding into a standardized bitstream and a subsequent decoding that is adaptable and agnostic to the speaker geometry (and number) and acoustic conditions at the location of the playback (involving a renderer).

To provide such flexibility for content creators, a hierarchical set of elements may be used to represent a soundfield. The hierarchical set of elements may refer to a set of elements in which the elements are ordered such that a basic set of lower-ordered elements provides a full representation of the modeled soundfield. As the set is extended to include higher-order elements, the representation becomes more detailed, increasing resolution.

One example of a hierarchical set of elements is a set of spherical harmonic coefficients (SHC). The following expression demonstrates a description or representation of a soundfield using SHC:

$${p}_{i} ( t , {r}_{r} , {θ}_{r} , {ϕ}_{r} ) = {\sum }_{ω = 0}^{∞} [ 4 π {\sum }_{ω = 0}^{∞} {j}_{n} ( k {r}_{r} ) {\sum }_{m = - n}^{n} {A}_{n}^{m} ( k ) {Y}_{n}^{m} ( {θ}_{r} , {ϕ}_{r} ) ] {e}^{j ω t} ,$$

The expression shows that the pressure pᵢ at any point {rᵣ,θᵣ,φᵣ} of the soundfield, at time t, can be represented uniquely by the SHC, Aₙ^{m}(k). Here,

$$k = \frac{ω}{c} ,$$

c is the speed of sound (˜343 m/s), {rᵣ,θᵣ,φᵣ} is a point of reference (or observation point), jₙ(•) is the spherical Bessel function of order n, and Yₙ^{m}(θᵣ,φᵣ) are the spherical harmonic basis functions of order n and suborder m. It can be recognized that the term in square brackets is a frequency-domain representation of the signal (i.e., S(ω,rᵣ,θᵣ,φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

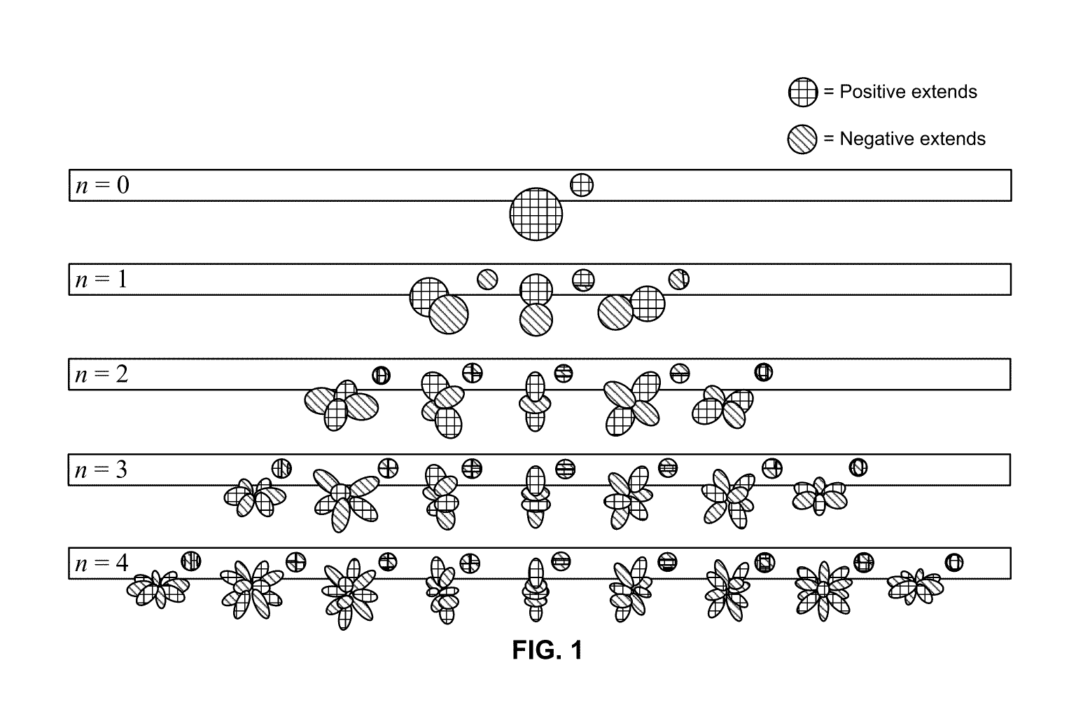

FIG. 1 is a diagram illustrating spherical harmonic basis functions from the zero order (n=0) to the fourth order (n=4). As can be seen, for each order, there is an expansion of suborders m which are shown but not explicitly noted in the example of FIG. 1 for ease of illustration purposes.

The SHC Aₙ^{m}(k) can either be physically acquired (e.g., recorded) by various microphone array configurations or, alternatively, they can be derived from channel-based or object-based descriptions of the soundfield. The SHC represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

To illustrate how the SHCs may be derived from an object-based description, consider the following equation. The coefficients Aₙ^{m}(k) for the soundfield corresponding to an individual audio object may be expressed as:

Aₙ^{m}(k)=g(ω)(−4πik)hₙ⁽²⁾(ktₛ)Yₙ^{m*}(θₛ,φₛ),

where i is \sqrt{−1}, hₙ⁽²⁾(•) is the spherical Hankel function (of the second kind) of order n, and {rₛ,θₛ,φₛ} is the location of the object. Knowing the object source energy g(ω) as a function of frequency (e.g., using time-frequency analysis techniques, such as performing a fast Fourier transform on the PCM stream) allows us to convert each PCM object and the corresponding location into the SHC Aₙ^{m}(k). Further, it can be shown (since the above is a linear and orthogonal decomposition) that the Aₙ^{m}(k) coefficients for each object are additive. In this manner, a multitude of PCM objects can be represented by the Aₙ^{m}(k) coefficients (e.g., as a sum of the coefficient vectors for the individual objects). Essentially, the coefficients contain information about the soundfield (the pressure as a function of 3D coordinates), and the above represents the transformation from individual objects to a representation of the overall soundfield, in the vicinity of the observation point {rᵣ,θᵣ,φᵣ}. The remaining figures are described below in the context of object-based and SHC-based audio coding.

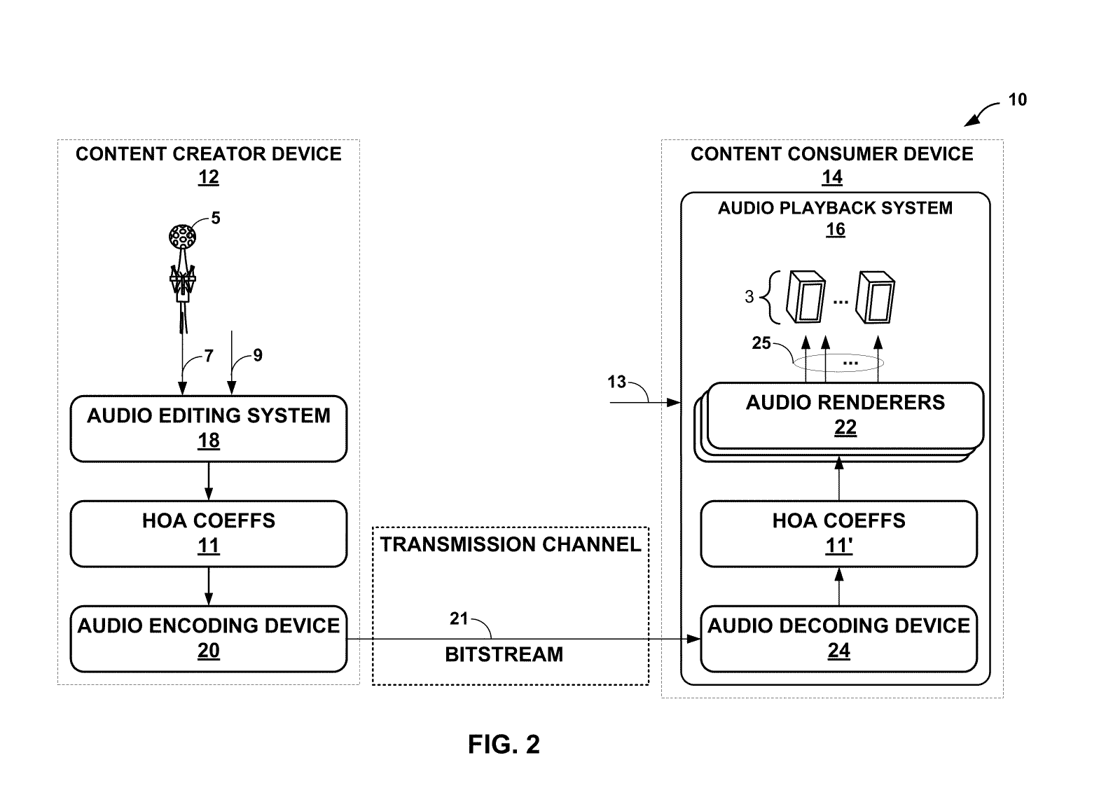

FIG. 2 is a diagram illustrating a system 10 that may perform various aspects of the techniques described in this disclosure. As shown in the example of FIG. 2, the system 10 includes a content creator device 12 and a content consumer device 14. While described in the context of the content creator device 12 and the content consumer device 14, the techniques may be implemented in any context in which SHCs (which may also be referred to as HOA coefficients) or any other hierarchical representation of a soundfield are encoded to form a bitstream representative of the audio data. Moreover, the content creator device 12 may represent any form of computing device capable of implementing the techniques described in this disclosure, including a handset (or cellular phone), a tablet computer, a smart phone, or a desktop computer to provide a few examples. Likewise, the content consumer device 14 may represent any form of computing device capable of implementing the techniques described in this disclosure, including a handset (or cellular phone), a tablet computer, a smart phone, a set-top box, or a desktop computer to provide a few examples.

The content creator device 12 may be operated by a movie studio or other entity that may generate multi-channel audio content for consumption by operators of content consumer devices, such as the content consumer device 14. In some examples, the content creator device 12 may be operated by an individual user who would like to compress HOA coefficients 11. Often, the content creator generates audio content in conjunction with video content. The content consumer device 14 may be operated by an individual. The content consumer device 14 may include an audio playback system 16, which may refer to any form of audio playback system capable of rendering SHC for play back as multi-channel audio content.

The content creator device 12 includes an audio editing system 18. The content creator device 12 obtain live recordings 7 in various formats (including directly as HOA coefficients) and audio objects 9, which the content creator device 12 may edit using audio editing system 18. A microphone 5 may capture the live recordings 7. The content creator may, during the editing process, render HOA coefficients 11 from audio objects 9, listening to the rendered speaker feeds in an attempt to identify various aspects of the soundfield that require further editing. The content creator device 12 may then edit HOA coefficients 11 (potentially indirectly through manipulation of different ones of the audio objects 9 from which the source HOA coefficients may be derived in the manner described above). The content creator device 12 may employ the audio editing system 18 to generate the HOA coefficients 11. The audio editing system 18 represents any system capable of editing audio data and outputting the audio data as one or more source spherical harmonic coefficients.

When the editing process is complete, the content creator device 12 may generate a bitstream 21 based on the HOA coefficients 11. That is, the content creator device 12 includes an audio encoding device 20 that represents a device configured to encode or otherwise compress HOA coefficients 11 in accordance with various aspects of the techniques described in this disclosure to generate the bitstream 21. The audio encoding device 20 may generate the bitstream 21 for transmission, as one example, across a transmission channel, which may be a wired or wireless channel, a data storage device, or the like. The bitstream 21 may represent an encoded version of the HOA coefficients 11 and may include a primary bitstream and another side bitstream, which may be referred to as side channel information.

While shown in FIG. 2 as being directly transmitted to the content consumer device 14, the content creator device 12 may output the bitstream 21 to an intermediate device positioned between the content creator device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the content consumer device 14, requesting the bitstream 21.

Alternatively, the content creator device 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 2.

As further shown in the example of FIG. 2, the content consumer device 14 includes the audio playback system 16. The audio playback system 16 may represent any audio playback system capable of playing back multi-channel audio data. The audio playback system 16 may include a number of different renderers 22. The renderers 22 may each provide for a different form of rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16 may further include an audio decoding device 24. The audio decoding device 24 may represent a device configured to decode HOA coefficients 11′ from the bitstream 21, where the HOA coefficients 11′ may be similar to the HOA coefficients 11 but differ due to lossy operations (e.g., quantization) and/or transmission via the transmission channel. The audio playback system 16 may, after decoding the bitstream 21 to obtain the HOA coefficients 11′ and render the HOA coefficients 11′ to output loudspeaker feeds 25. The loudspeaker feeds 25 may drive one or more loudspeakers (which are not shown in the example of FIG. 2 for ease of illustration purposes).

To select the appropriate renderer or, in some instances, generate an appropriate renderer, the audio playback system 16 may obtain loudspeaker information 13 indicative of a number of loudspeakers and/or a spatial geometry of the loudspeakers. In some instances, the audio playback system 16 may obtain the loudspeaker information 13 using a reference microphone and driving the loudspeakers in such a manner as to dynamically determine the loudspeaker information 13. In other instances or in conjunction with the dynamic determination of the loudspeaker information 13, the audio playback system 16 may prompt a user to interface with the audio playback system 16 and input the loudspeaker information 13.

The audio playback system 16 may then select one of the audio renderers 22 based on the loudspeaker information 13. In some instances, the audio playback system 16 may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16 may, in some instances, generate one of the audio renderers 22 based on the loudspeaker information 13 without first attempting to select an existing one of the audio renderers 22. One or more speakers 3 may then playback the rendered loudspeaker feeds 25.

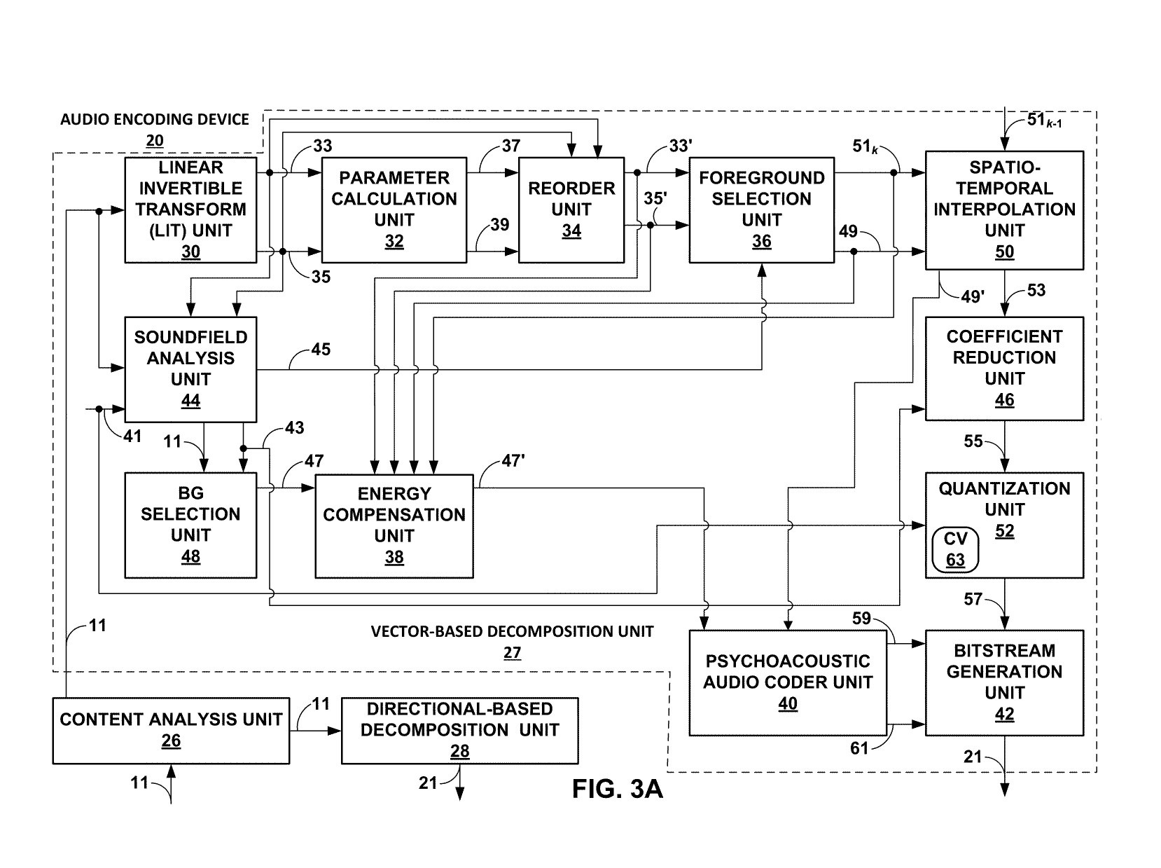

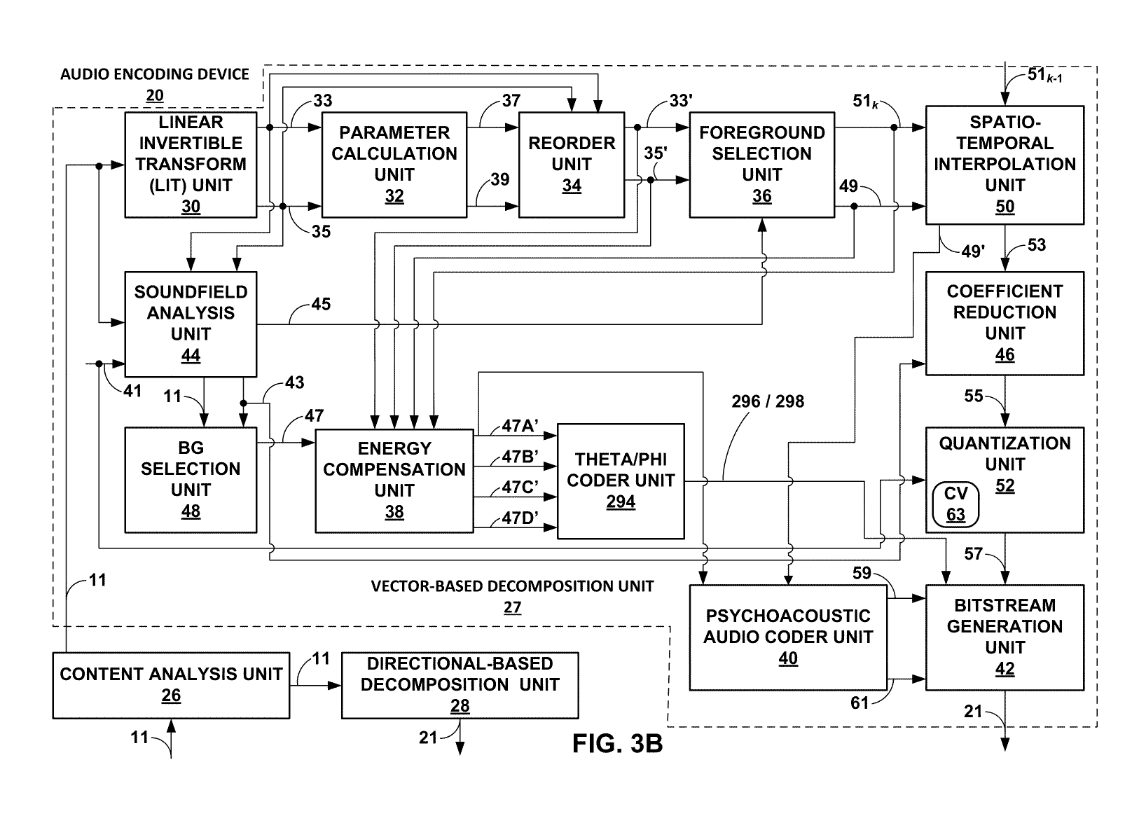

FIG. 3A is a block diagram illustrating, in more detail, one example of the audio encoding device 20 shown in the example of FIG. 2 that may perform various aspects of the techniques described in this disclosure. The audio encoding device 20 includes a content analysis unit 26, a vector-based decomposition unit 27 and a directional-based decomposition unit 28. Although described briefly below, more information regarding the audio encoding device 20 and the various aspects of compressing or otherwise encoding HOA coefficients is available in International Patent Application Publication No. WO 2014/194099, entitled “INTERPOLATION FOR DECOMPOSED REPRESENTATIONS OF A SOUND FIELD,” filed 29 May, 2014.

The content analysis unit 26 represents a unit configured to analyze the content of the HOA coefficients 11 to identify whether the HOA coefficients 11 represent content generated from a live recording or an audio object. The content analysis unit 26 may determine whether the HOA coefficients 11 were generated from a recording of an actual soundfield or from an artificial audio object. In some instances, when the framed HOA coefficients 11 were generated from a recording, the content analysis unit 26 passes the HOA coefficients 11 to the vector-based decomposition unit 27. In some instances, when the framed HOA coefficients 11 were generated from a synthetic audio object, the content analysis unit 26 passes the HOA coefficients 11 to the directional-based synthesis unit 28. The directional-based synthesis unit 28 may represent a unit configured to perform a directional-based synthesis of the HOA coefficients 11 to generate a directional-based bitstream 21.

As shown in the example of FIG. 3A, the vector-based decomposition unit 27 may include a linear invertible transform (LIT) unit 30, a parameter calculation unit 32, a reorder unit 34, a foreground selection unit 36, an energy compensation unit 38, a psychoacoustic audio coder unit 40, a bitstream generation unit 42, a soundfield analysis unit 44, a coefficient reduction unit 46, a background (BG) selection unit 48, a spatio-temporal interpolation unit 50, and a quantization unit 52.

The linear invertible transform (LIT) unit 30 receives the HOA coefficients 11 in the form of HOA channels, each channel representative of a block or frame of a coefficient associated with a given order, sub-order of the spherical basis functions (which may be denoted as HOA[k], where k may denote the current frame or block of samples). The matrix of HOA coefficients 11 may have dimensions D: M×(N+1)².

The LIT unit 30 may represent a unit configured to perform a form of analysis referred to as singular value decomposition. While described with respect to SVD, the techniques described in this disclosure may be performed with respect to any similar transformation or decomposition that provides for sets of linearly uncorrelated, energy compacted output. Also, reference to “sets” in this disclosure is generally intended to refer to non-zero sets unless specifically stated to the contrary and is not intended to refer to the classical mathematical definition of sets that includes the so-called “empty set.” An alternative transformation may comprise a principal component analysis, which is often referred to as “PCA.” Depending on the context, PCA may be referred to by a number of different names, such as discrete Karhunen-Loeve transform, the Hotelling transform, proper orthogonal decomposition (POD), and eigenvalue decomposition (EVD) to name a few examples. Properties of such operations that are conducive to the underlying goal of compressing audio data are ‘energy compaction’ and ‘decorrelation’ of the multichannel audio data.

In any event, assuming the LIT unit 30 performs a singular value decomposition (which, again, may be referred to as “SVD”) for purposes of example, the LIT unit 30 may transform the HOA coefficients 11 into two or more sets of transformed HOA coefficients. The “sets” of transformed HOA coefficients may include vectors of transformed HOA coefficients. In the example of FIG. 3A, the LIT unit 30 may perform the SVD with respect to the HOA coefficients 11 to generate a so-called V matrix, an S matrix, and a U matrix. SVD, in linear algebra, may represent a factorization of a y-by-z real or complex matrix X (where X may represent multi-channel audio data, such as the HOA coefficients 11) in the following form:

X=USV*

U may represent a y-by-y real or complex unitary matrix, where the y columns of U are known as the left-singular vectors of the multi-channel audio data. S may represent a y-by-z rectangular diagonal matrix with non-negative real numbers on the diagonal, where the diagonal values of S are known as the singular values of the multi-channel audio data. V* (which may denote a conjugate transpose of V) may represent a z-by-z real or complex unitary matrix, where the z columns of V* are known as the right-singular vectors of the multi-channel audio data.

In some examples, the V* matrix in the SVD mathematical expression referenced above is denoted as the conjugate transpose of the V matrix to reflect that SVD may be applied to matrices comprising complex numbers. When applied to matrices comprising only real-numbers, the complex conjugate of the V matrix (or, in other words, the V* matrix) may be considered to be the transpose of the V matrix. Below it is assumed, for ease of illustration purposes, that the HOA coefficients 11 comprise real-numbers with the result that the V matrix is output through SVD rather than the V* matrix. Moreover, while denoted as the V matrix in this disclosure, reference to the V matrix should be understood to refer to the transpose of the V matrix where appropriate. While assumed to be the V matrix, the techniques may be applied in a similar fashion to HOA coefficients 11 having complex coefficients, where the output of the SVD is the V* matrix. Accordingly, the techniques should not be limited in this respect to only provide for application of SVD to generate a V matrix, but may include application of SVD to HOA coefficients 11 having complex components to generate a V* matrix.

In this way, the LIT unit 30 may perform SVD with respect to the HOA coefficients 11 to output US[k] vectors 33 (which may represent a combined version of the S vectors and the U vectors) having dimensions D: M×(N+1)², and V[k] vectors 35 having dimensions D: (N+1)²×(N+1)². Individual vector elements in the US[k] matrix may also be termed X_{PS}(k) while individual vectors of the V[k] matrix may also be termed v(k).

An analysis of the U, S and V matrices may reveal that the matrices carry or represent spatial and temporal characteristics of the underlying soundfield represented above by X. Each of the N vectors in U (of length M samples) may represent normalized separated audio signals as a function of time (for the time period represented by M samples), that are orthogonal to each other and that have been decoupled from any spatial characteristics (which may also be referred to as directional information). The spatial characteristics, representing spatial shape and position (r, theta, phi) may instead be represented by individual i^{th} vectors, v⁽ⁱ⁾(k), in the V matrix (each of length (N+1)²). The individual elements of each of v⁽ⁱ⁾(k) vectors may represent an HOA coefficient describing the shape (including width) and position of the soundfield for an associated audio object. Both the vectors in the U matrix and the V matrix are normalized such that their root-mean-square energies are equal to unity. The energy of the audio signals in U are thus represented by the diagonal elements in S. Multiplying U and S to form US[k] (with individual vector elements X_{PS}(k)), thus represent the audio signal with energies. The ability of the SVD decomposition to decouple the audio time-signals (in U), their energies (in S) and their spatial characteristics (in V) may support various aspects of the techniques described in this disclosure. Further, the model of synthesizing the underlying HOA[k] coefficients, X, by a vector multiplication of US[k] and V[k] gives rise the term “vector-based decomposition,” which is used throughout this document.

Although described as being performed directly with respect to the HOA coefficients 11, the LIT unit 30 may apply the linear invertible transform to derivatives of the HOA coefficients 11. For example, the LIT unit 30 may apply SVD with respect to a power spectral density matrix derived from the HOA coefficients 11. By performing SVD with respect to the power spectral density (PSD) of the HOA coefficients rather than the coefficients themselves, the LIT unit 30 may potentially reduce the computational complexity of performing the SVD in terms of one or more of processor cycles and storage space, while achieving the same source audio encoding efficiency as if the SVD were applied directly to the HOA coefficients.

The parameter calculation unit 32 represents a unit configured to calculate various parameters, such as a correlation parameter (R), directional properties parameters (θ, ω, r), and an energy property (e). Each of the parameters for the current frame may be denoted as R[k], θ[k], φ[k], r[k] and e[k]. The parameter calculation unit 32 may perform an energy analysis and/or correlation (or so-called cross-correlation) with respect to the US[k] vectors 33 to identify the parameters. The parameter calculation unit 32 may also determine the parameters for the previous frame, where the previous frame parameters may be denoted R[k−1], θ[k−1], φ[k−1], r[k−1] and e[k−1], based on the previous frame of US[k−1] vector and V[k−1] vectors. The parameter calculation unit 32 may output the current parameters 37 and the previous parameters 39 to reorder unit 34.

The parameters calculated by the parameter calculation unit 32 may be used by the reorder unit 34 to re-order the audio objects to represent their natural evaluation or continuity over time. The reorder unit 34 may compare each of the parameters 37 from the first US[k] vectors 33 turn-wise against each of the parameters 39 for the second US[k−1] vectors 33. The reorder unit 34 may reorder (using, as one example, a Hungarian algorithm) the various vectors within the US[k] matrix 33 and the V[k] matrix 35 based on the current parameters 37 and the previous parameters 39 to output a reordered US[k] matrix 33′ (which may be denoted mathematically as U̅S̅[k]) and a reordered V[k] matrix 35′ (which may be denoted mathematically as V̅[k]) to a foreground sound (or predominant sound—PS) selection unit 36 (“foreground selection unit 36”) and an energy compensation unit 38.

The soundfield analysis unit 44 may represent a unit configured to perform a soundfield analysis with respect to the HOA coefficients 11 so as to potentially achieve a target bitrate 41. The soundfield analysis unit 44 may, based on the analysis and/or on a received target bitrate 41, determine the total number of psychoacoustic coder instantiations (which may be a function of the total number of ambient or background channels (BG_{TOT}) and the number of foreground channels or, in other words, predominant channels. The total number of psychoacoustic coder instantiations can be denoted as numHOATransportChannels.

The soundfield analysis unit 44 may also determine, again to potentially achieve the target bitrate 41, the total number of foreground channels (nFG) 45, the minimum order of the background (or, in other words, ambient) soundfield (N_{BG} or, alternatively, MinAmbHOAorder), the corresponding number of actual channels representative of the minimum order of background soundfield (nBGa=(MinAmbHOAorder+1)²), and indices (i) of additional BG HOA channels to send (which may collectively be denoted as background channel information 43 in the example of FIG. 3A). The background channel information 42 may also be referred to as ambient channel information 43. Each of the channels that remains from numHOATransportChannels−nBGa, may either be an “additional background/ambient channel”, an “active vector-based predominant channel”, an “active directional based predominant signal” or “completely inactive”. In one aspect, the channel types may be indicated (as a “ChannelType”) syntax element by two bits (e.g. 00: directional based signal; 01: vector-based predominant signal; 10: additional ambient signal; 11: inactive signal). The total number of background or ambient signals, nBGa, may be given by (MinAmbHOAorder+1)²+the number of times the index 10 (in the above example) appears as a channel type in the bitstream for that frame.

The soundfield analysis unit 44 may select the number of background (or, in other words, ambient) channels and the number of foreground (or, in other words, predominant) channels based on the target bitrate 41, selecting more background and/or foreground channels when the target bitrate 41 is relatively higher (e.g., when the target bitrate 41 equals or is greater than 512 Kbps). In one aspect, the numHOATransportChannels may be set to 8 while the MinAmbHOAorder may be set to 1 in the header section of the bitstream. In this scenario, at every frame, four channels may be dedicated to represent the background or ambient portion of the soundfield while the other 4 channels can, on a frame-by-frame basis vary on the type of channel—e.g., either used as an additional background/ambient channel or a foreground/predominant channel. The foreground/predominant signals can be one of either vector-based or directional based signals, as described above.

In some instances, the total number of vector-based predominant signals for a frame, may be given by the number of times the ChannelType index is 01 in the bitstream of that frame. In the above aspect, for every additional background/ambient channel (e.g., corresponding to a ChannelType of 10), corresponding information of which of the possible HOA coefficients (beyond the first four) may be represented in that channel. The information, for fourth order HOA content, may be an index to indicate the HOA coefficients 5-25. The first four ambient HOA coefficients 1-4 may be sent all the time when minAmbHOAorder is set to 1, hence the audio encoding device may only need to indicate one of the additional ambient HOA coefficient having an index of 5-25. The information could thus be sent using a 5 bits syntax element (for 4^{th} order content), which may be denoted as “CodedAmbCoeffIdx.” In any event, the soundfield analysis unit 44 outputs the background channel information 43 and the HOA coefficients 11 to the background (BG) selection unit 36, the background channel information 43 to coefficient reduction unit 46 and the bitstream generation unit 42, and the nFG 45 to a foreground selection unit 36.

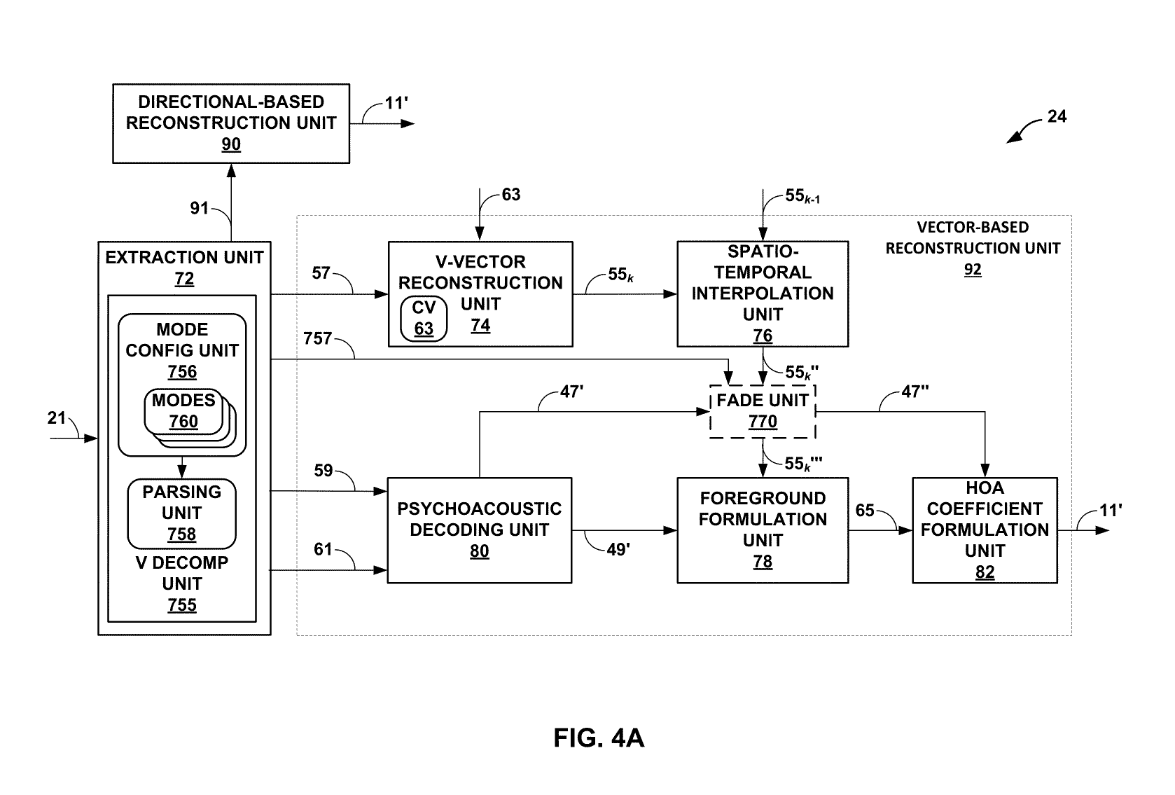

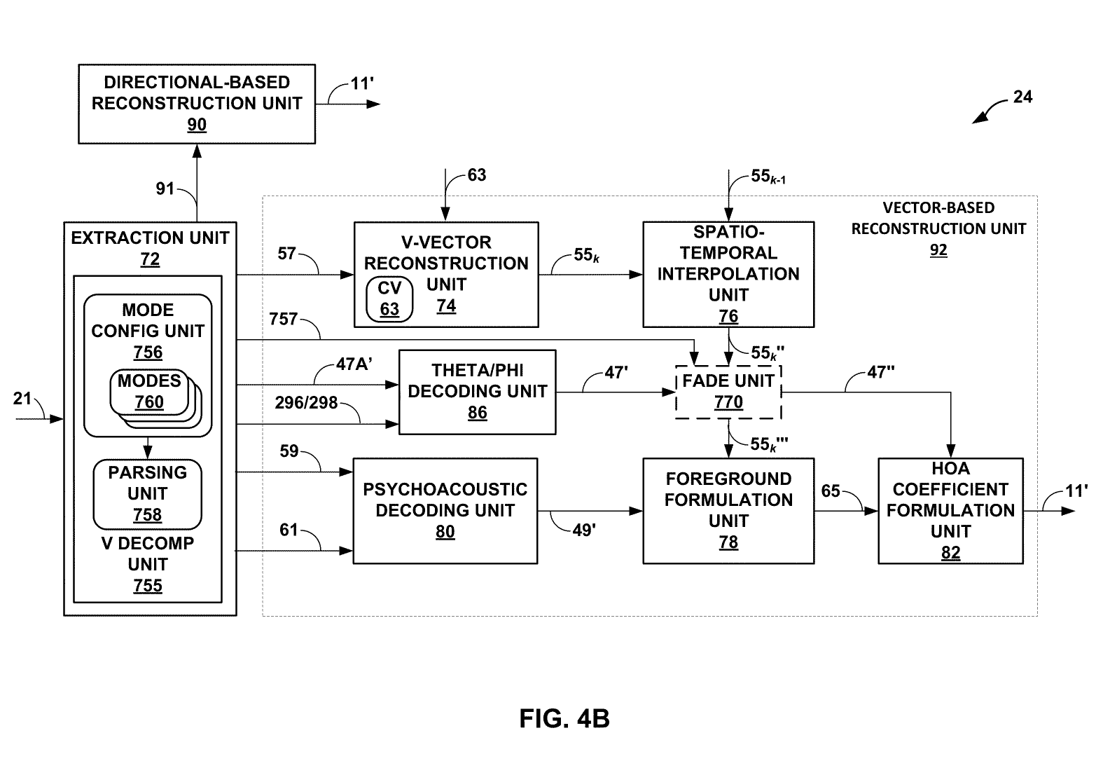

The background selection unit 48 may represent a unit configured to determine background or ambient HOA coefficients 47 based on the background channel information (e.g., the background soundfield (N_{BG}) and the number (nBGa) and the indices (i) of additional BG HOA channels to send). For example, when N_{BG} equals one, the background selection unit 48 may select the HOA coefficients 11 for each sample of the audio frame having an order equal to or less than one. The background selection unit 48 may, in this example, then select the HOA coefficients 11 having an index identified by one of the indices (i) as additional BG HOA coefficients, where the nBGa is provided to the bitstream generation unit 42 to be specified in the bitstream 21 so as to enable the audio decoding device, such as the audio decoding device 24 shown in the example of FIGS. 2 and 4, to parse the background HOA coefficients 47 from the bitstream 21. The background selection unit 48 may then output the ambient HOA coefficients 47 to the energy compensation unit 38. The ambient HOA coefficients 47 may have dimensions D: M×[(N_{BG}+1)²₊nBGa]. The ambient HOA coefficients 47 may also be referred to as “ambient HOA coefficients 47,” where each of the ambient HOA coefficients 47 corresponds to a separate ambient HOA channel 47 to be encoded by the psychoacoustic audio coder unit 40.

The foreground selection unit 36 may represent a unit configured to select the reordered US[k] matrix 33′ and the reordered V[k] matrix 35′ that represent foreground or distinct components of the soundfield based on nFG 45 (which may represent a one or more indices identifying the foreground vectors). The foreground selection unit 36 may output nFG signals 49 (which may be denoted as a reordered US[k]_{1, . . . , nFG} 49, FG_{1, . . . , nFG}[k] 49, or X_{PS}^{(1 . . . nFG)}(k) 49) to the psychoacoustic audio coder unit 40, where the nFG signals 49 may have dimensions D: M×nFG and each represent mono-audio objects. The foreground selection unit 36 may also output the reordered V[k] matrix 35′ (or v^{(1 . . . nFG)}(k) 35′) corresponding to foreground components of the soundfield to the spatio-temporal interpolation unit 50, where a subset of the reordered V[k] matrix 35′ corresponding to the foreground components may be denoted as foreground V[k] matrix 51ₖ (which may be mathematically denoted as V̅_{1, . . . , nFG} [k]) having dimensions D: (N+1)²×nFG.

The energy compensation unit 38 may represent a unit configured to perform energy compensation with respect to the ambient HOA coefficients 47 to compensate for energy loss due to removal of various ones of the HOA channels by the background selection unit 48. The energy compensation unit 38 may perform an energy analysis with respect to one or more of the reordered US[k] matrix 33′, the reordered V[k] matrix 35′, the nFG signals 49, the foreground V[k] vectors 51ₖ and the ambient HOA coefficients 47 and then perform energy compensation based on the energy analysis to generate energy compensated ambient HOA coefficients 47′. The energy compensation unit 38 may output the energy compensated ambient HOA coefficients 47′ to the psychoacoustic audio coder unit 40.

The spatio-temporal interpolation unit 50 may represent a unit configured to receive the foreground V[k] vectors 51ₖ for the k^{th} frame and the foreground V[k−1] vectors 51ₖ₋₁ for the previous frame (hence the k−1 notation) and perform spatio-temporal interpolation to generate interpolated foreground V[k] vectors. The spatio-temporal interpolation unit 50 may recombine the nFG signals 49 with the foreground V[k] vectors 51ₖ to recover reordered foreground HOA coefficients. The spatio-temporal interpolation unit 50 may then divide the reordered foreground HOA coefficients by the interpolated V[k] vectors to generate interpolated nFG signals 49′. The spatio-temporal interpolation unit 50 may also output the foreground V[k] vectors 51ₖ that were used to generate the interpolated foreground V[k] vectors so that an audio decoding device, such as the audio decoding device 24, may generate the interpolated foreground V[k] vectors and thereby recover the foreground V[k] vectors 51ₖ. The foreground V[k] vectors 51ₖ used to generate the interpolated foreground V[k] vectors are denoted as the remaining foreground V[k] vectors 53. In order to ensure that the same V[k] and V[k−1] are used at the encoder and decoder (to create the interpolated vectors V[k]) quantized/dequantized versions of the vectors may be used at the encoder and decoder. The spatio-temporal interpolation unit 50 may output the interpolated nFG signals 49′ to the psychoacoustic audio coder unit 46 and the interpolated foreground V[k] vectors 51ₖ to the coefficient reduction unit 46.

The coefficient reduction unit 46 may represent a unit configured to perform coefficient reduction with respect to the remaining foreground V[k] vectors 53 based on the background channel information 43 to output reduced foreground V[k] vectors 55 to the quantization unit 52. The reduced foreground V[k] vectors 55 may have dimensions D: [(N+1)²−(N_{BG}+1)²−BG_{TOT}]×nFG. The coefficient reduction unit 46 may, in this respect, represent a unit configured to reduce the number of coefficients in the remaining foreground V[k] vectors 53. In other words, coefficient reduction unit 46 may represent a unit configured to eliminate the coefficients in the foreground V[k] vectors (that form the remaining foreground V[k] vectors 53) having little to no directional information. In some examples, the coefficients of the distinct or, in other words, foreground V[k] vectors corresponding to a first and zero order basis functions (which may be denoted as N_{BG}) provide little directional information and therefore can be removed from the foreground V-vectors (through a process that may be referred to as “coefficient reduction”). In this example, greater flexibility may be provided to not only identify the coefficients that correspond N_{BG} but to identify additional HOA channels (which may be denoted by the variable TotalOfAddAmbHOAChan) from the set of [(N_{BG}+1)²+1, (N+1)²].

The quantization unit 52 may represent a unit configured to perform any form of quantization to compress the reduced foreground V[k] vectors 55 to generate coded foreground V[k] vectors 57, outputting the coded foreground V[k] vectors 57 to the bitstream generation unit 42. In operation, the quantization unit 52 may represent a unit configured to compress a spatial component of the soundfield, i.e., one or more of the reduced foreground V[k] vectors 55 in this example. The quantization unit 52 may perform any one of the following 12 quantization modes, as indicated by a quantization mode syntax element denoted “NbitsQ”:

| NbitsQ value | Type of Quantization Mode |
|---|---|
| 0-3: | Reserved |
| 4: | Vector Quantization |
| 5: | Scalar Quantization without Huffman Coding |
| 6: | 6-bit Scalar Quantization with Huffman Coding |
| 7: | 7-bit Scalar Quantization with Huffman Coding |
| 8: | 8-bit Scalar Quantization with Huffman Coding |
| . . . | . . . |
| 16: | 16-bit Scalar Quantization with Huffman Coding |

The quantization unit 52 may also perform predicted versions of any of the foregoing types of quantization modes, where a difference is determined between an element of (or a weight when vector quantization is performed) of the V-vector of a previous frame and the element (or weight when vector quantization is performed) of the V-vector of a current frame is determined. The quantization unit 52 may then quantize the difference between the elements or weights of the current frame and previous frame rather than the value of the element of the V-vector of the current frame itself.

The quantization unit 52 may perform multiple forms of quantization with respect to each of the reduced foreground V[k] vectors 55 to obtain multiple coded versions of the reduced foreground V[k] vectors 55. The quantization unit 52 may select the one of the coded versions of the reduced foreground V[k] vectors 55 as the coded foreground V[k] vector 57. The quantization unit 52 may, in other words, select one of the non-predicted vector-quantized V-vector, predicted vector-quantized V-vector, the non-Huffman-coded scalar-quantized V-vector, and the Huffman-coded scalar-quantized V-vector to use as the output switched-quantized V-vector based on any combination of the criteria discussed in this disclosure. In some examples, the quantization unit 52 may select a quantization mode from a set of quantization modes that includes a vector quantization mode and one or more scalar quantization modes, and quantize an input V-vector based on (or according to) the selected mode. The quantization unit 52 may then provide the selected one of the non-predicted vector-quantized V-vector (e.g., in terms of weight values or bits indicative thereof), predicted vector-quantized V-vector (e.g., in terms of error values or bits indicative thereof), the non-Huffman-coded scalar-quantized V-vector and the Huffman-coded scalar-quantized V-vector to the bitstream generation unit 52 as the coded foreground V[k] vectors 57. The quantization unit 52 may also provide the syntax elements indicative of the quantization mode (e.g., the NbitsQ syntax element) and any other syntax elements used to dequantize or otherwise reconstruct the V-vector.

The psychoacoustic audio coder unit 40 included within the audio encoding device 20 may represent multiple instances of a psychoacoustic audio coder, each of which is used to encode a different audio object or HOA channel of each of the energy compensated ambient HOA coefficients 47′ and the interpolated nFG signals 49′ to generate encoded ambient HOA coefficients 59 and encoded nFG signals 61. The psychoacoustic audio coder unit 40 may output the encoded ambient HOA coefficients 59 and the encoded nFG signals 61 to the bitstream generation unit 42.

The bitstream generation unit 42 included within the audio encoding device 20 represents a unit that formats data to conform to a known format (which may refer to a format known by a decoding device), thereby generating the vector-based bitstream 21. The bitstream 21 may, in other words, represent encoded audio data, having been encoded in the manner described above. The bitstream generation unit 42 may represent a multiplexer in some examples, which may receive the coded foreground V[k] vectors 57, the encoded ambient HOA coefficients 59, the encoded nFG signals 61 and the background channel information 43. The bitstream generation unit 42 may then generate a bitstream 21 based on the coded foreground V[k] vectors 57, the encoded ambient HOA coefficients 59, the encoded nFG signals 61 and the background channel information 43. In this way, the bitstream generation unit 42 may thereby specify the vectors 57 in the bitstream 21 to obtain the bitstream 21. The bitstream 21 may include a primary or main bitstream and one or more side channel bitstreams.

Although not shown in the example of FIG. 3A, the audio encoding device 20 may also include a bitstream output unit that switches the bitstream output from the audio encoding device 20 (e.g., between the directional-based bitstream 21 and the vector-based bitstream 21) based on whether a current frame is to be encoded using the directional-based synthesis or the vector-based synthesis. The bitstream output unit may perform the switch based on the syntax element output by the content analysis unit 26 indicating whether a directional-based synthesis was performed (as a result of detecting that the HOA coefficients 11 were generated from a synthetic audio object) or a vector-based synthesis was performed (as a result of detecting that the HOA coefficients were recorded). The bitstream output unit may specify the correct header syntax to indicate the switch or current encoding used for the current frame along with the respective one of the bitstreams 21.

Moreover, as noted above, the soundfield analysis unit 44 may identify BG_{TOT} ambient HOA coefficients 47, which may change on a frame-by-frame basis (although at times BG_{TOT} may remain constant or the same across two or more adjacent (in time) frames). The change in BG_{TOT} may result in changes to the coefficients expressed in the reduced foreground V[k] vectors 55. The change in BG_{TOT} may result in background HOA coefficients (which may also be referred to as “ambient HOA coefficients”) that change on a frame-by-frame basis (although, again, at times BG_{TOT} may remain constant or the same across two or more adjacent (in time) frames). The changes often result in a change of energy for the aspects of the sound field represented by the addition or removal of the additional ambient HOA coefficients and the corresponding removal of coefficients from or addition of coefficients to the reduced foreground V[k] vectors 55.

As a result, the soundfield analysis unit 44 may further determine when the ambient HOA coefficients change from frame to frame and generate a flag or other syntax element indicative of the change to the ambient HOA coefficient in terms of being used to represent the ambient components of the sound field (where the change may also be referred to as a “transition” of the ambient HOA coefficient or as a “transition” of the ambient HOA coefficient). In particular, the coefficient reduction unit 46 may generate the flag (which may be denoted as an AmbCoeffTransition flag or an AmbCoeffIdxTransition flag), providing the flag to the bitstream generation unit 42 so that the flag may be included in the bitstream 21 (possibly as part of side channel information).

The coefficient reduction unit 46 may, in addition to specifying the ambient coefficient transition flag, also modify how the reduced foreground V[k] vectors 55 are generated. In one example, upon determining that one of the ambient HOA ambient coefficients is in transition during the current frame, the coefficient reduction unit 46 may specify, a vector coefficient (which may also be referred to as a “vector element” or “element”) for each of the V-vectors of the reduced foreground V[k] vectors 55 that corresponds to the ambient HOA coefficient in transition. Again, the ambient HOA coefficient in transition may add or remove from the BG_{TOT} total number of background coefficients. Therefore, the resulting change in the total number of background coefficients affects whether the ambient HOA coefficient is included or not included in the bitstream, and whether the corresponding element of the V-vectors are included for the V-vectors specified in the bitstream in the second and third configuration modes described above. More information regarding how the coefficient reduction unit 46 may specify the reduced foreground V[k] vectors 55 to overcome the changes in energy is provided in U.S. application Ser. No. 14/594,533, entitled “TRANSITIONING OF AMBIENT HIGHER_ORDER AMBISONIC COEFFICIENTS,” filed Jan. 12, 2015.

FIG. 3B is a block diagram illustrating, in more detail, another example of the audio encoding device 20 shown in the example of FIG. 2 that may perform various aspects of the techniques described in this disclosure. The audio encoding device 20 of FIG. 3B includes many components similar to that of audio encoding device 20 of FIG. 3A. In the example of FIG. 3B, the energy compensation unit 38 may perform an energy analysis with respect to one or more of the reordered US[k] matrix 33′, the reordered V[k] matrix 35′, the nFG signals 49, the foreground V[k] vectors 51ₖ and the ambient HOA coefficients 47 and then perform energy compensation based on this energy analysis to generate energy compensated ambient HOA coefficients 47A′-47D′ (collectively, “HOA coefficients 47′”). HOA coefficients 47A′ may represent the zero order HOA channel, also known as the ‘W’ or omnidirectional channel, while HOA coefficients 47B′, 47C′, and 47D′ may represent the first-order HOA channels X, Y, and Z, respectively. The X, Y, and Z channels may each have the pattern of a dipole directed along one of the Cartesian axes.

In some examples, each of HOA coefficients 47′ may be expressed in a two-dimensional time-frequency domain (e.g., the Short-Time Fourier Transform (STFT) domain), whereby each HOA coefficients 47′ (the W, X, Y, Z channels) are successive time-frequency matrices. Each frequency vector of a matrix may represent a channel for a single audio frame, with successive audio frames of frequency vectors combining to form a time-frequency matrix over time. The energy compensation unit 38 may output the energy compensated ambient HOA coefficients 47′ to the theta/phi coder unit 294. In some examples, the theta/phi coder unit 294 transforms each of HOA coefficients 47′ to a time-frequency domain prior to determination of a spatial relation.

If the HOA coefficients 47B′-47D′ have only directional components, they may be ideally represented by a spatial relation of the HOA coefficients 47B′-47D′ (e.g., X, Y, Z channels) with HOA coefficients 47A′ (W channel). In accordance with techniques described in this disclosure, theta/phi coder unit 294 determines the spatial relation of the HOA coefficients 47B′-47D′ with HOA coefficients 47A′ to determine theta (θ) representing the azimuth and phi (Φ or φ) representing the elevation for a 3D vector that expresses a direction opposite that of the directional flow of sound energy for the HOA coefficients 47B′-47D′ for at least one frequency band within the frequency range of the HOA coefficients 47′ as determined by the transform function to the time-frequency domain (the transform function being applied by energy compensation unit 38 or theta/phi coder unit 294, for instance). Theta/phi coder unit 294 may determine theta/phi values for each of the frequency bands of the frequency range, up to an including frequency bands equal to a single bin and a single frequency band that spans the entirety of the frequency range. In some examples, the time-frequency matrices include 1024 frequency bins and each frequency band includes 16 bins. In such examples, theta/phi coder unit 294 may determine theta/phi values for each of the 64 frequency bands (1024/16).

Theta/phi coder unit 294 determines spatial information (theta/phi values) from the relation between the HOA coefficients 47A′ and HOA coefficients 47B′-47D′. Theta/phi coder unit 294 may first determine a W′ signal that is the power sum of each channel in the same order; this W′ signal may represent a quantized form of the W channel or HOA coefficients 47A′. If the HOA coefficients 47B′-47D′ are entirely directional (i.e., do not include any diffuse components), the W′ signal is equivalent to the W channel. When the directional components are thus separated from the signals, the components may be encoded with spatial information, here, in the form of theta/phi values.

In some examples, theta/phi coder unit 294 determines theta/phi values for a frequency band to minimize the total error in the frequency band according to an error criterion for error between a signal according the spatial model and the original signal (i.e., any of HOA coefficients 47B′-47D′), where the total error refers to the combination (e.g., sum) of errors for each frequency bin in the frequency band. In some examples, the error criterion is the mean squared error (MSE) for each frequency bin, which may be combined (e.g., summed) over the frequency band to arrive at the total error for the frequency band.

The signal model for synthesized signals \hat{X}, Ŷ, \hat{Z} (corresponding to original signals X, Y, Z, respectively and respective HOA coefficients 47B′-47D′) according to a spatial relation with the W channel (HOA coefficients 47A′) may conform to the following equation A-1:

\hat{X}=W cos θ cos φ,Ŷ=W sin θ cos φ,\hat{Z}=W sin φ. (A-1)

In equation A-1, W may represent the W′ signal. Using MSE as the error criterion for a frequency band, the MSE for the frequency band may conform to the following equation A-2:

E=Σ_{k=B(i)}^{B(i+1)}{(Xₖ−\hat{X}ₖ)²+(Yₖ−Ŷₖ)²+(Zₖ−\hat{Z}ₖ)²}, (A-2)

In A-2, the mean squared error, E, is computed as the sum of errors for the frequency bins, k, in a frequency band, [B(i)→B(i+1)]. In other words, the sum of errors over k frequency bins in the frequency band. The error for a frequency bin, k, is itself the sum of the error (difference) between the original signal and the synthesized signal for each of the X, Y, Z channels. Grouping the frequency bins into a multiple bins may reduce the bitrate of the generated spatial information.

In accordance with equations A-1 and A-2, therefore, theta/phi coder unit 294 may estimate or determine a theta value for a frequency band B(i) according to equation A-3:

$$sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}} \qquad ( A \text{-} 3 )$$

and may further estimate a phi value for the frequency band B(i) according to equation A-4:

$$sin {ϕ}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}} , \qquad ( A \text{-} 4 )$$

W in equations A-3 and A-4 may represent the W′ signal. Each of X, Y, and Z may represent the original HOA coefficients 47B′, 47C′, and 47D′, respectively. Each of frequency bands B(i) may be substantially independent of one another as regards the spatial information. Furthermore, although described with respect to only the first order SHC channels, theta/phi coder unit 294 may in some examples apply the techniques of this disclosure to determine spatial information for higher order SHC channels.

Theta/phi coder unit 294 outputs spatial information 296 as theta/phi values for the one or more frequency bands. Bitstream generation unit 42 quantizes the theta/phi values. In some examples, bitstream generation unit 42 performs delta coding, for instance in cases in which the sound source generally moves slowly in the small time slot from theta/phi value pair to the next theta/phi value pair for each frequency band. In such examples, bitstream generation unit 42 may allocate a larger number of bits for for coding for higher-frequency frequency bands than for lower-frequency bands.

Theta/phi as determined by theta/phi coder unit 294 may be bound to different scales for different frequency bands, with a larger scale for the higher frequencies. Bitstream generation unit 42 may transmit the average values for the spatial information 296 in bitstream 21. In this way, fewer bits may be allocated for “less important” frequency bands considered psycho-acoustically. In some examples, an audio encoding device 20 may use theta/phi coder unit 294 to determine spatial information for background channels in an SVD-based HOA compression system. The techniques may reduce redundancies in the outputted bitstream 21 for representations of the various component signals of the HOA coefficients 47.

In some examples, the theta/phi coder unit 294 may determine the energy compensated ambient HOA coefficients 47B′-47D′ in accordance with a slightly different signaling model that considers the sign of the X, Y and Z channels. This slightly different signaling model may be expressed mathematically as follows:

\hat{X}=Ŵ cos θ cos φ signX,Ŷ=Ŵ sin θ cos φ signY,\hat{Z}=Ŵ sin φ signZ (A-5)

In the foregoing example, signA (where A may represent X, Y or Z) may refer to the following equation:

signA=sign(cos(angle(W)−angle(A))) (A-6)

In this signaling model, the time version of each of signal may be denoted as x(i), y(i) and z(i) and the time-frequency version may be denoted as X(i), Y(i) and Z(i). In this signaling model, the X, Y, and Z refer to time-frequency signals having been converted to the time-frequency domain through application by the theta/phi coding unit 294 of a quadrature mirror filter or any other type of filter capable of converting a time domain signal to the time-frequency domain. The X, Y, and Z signals may be complex numbers from which an angle may be calculated. The sign function therefore returns either a positive one or a negative one.

The theta/phi coder unit 294 may employ this slightly different or, in other words, sign-based signaling synthesis model to reduce artifacts introduced due to frame boundaries that may cause such sign changes. Various aspects of the techniques described in this disclosure may enable the theta/phi coder unit 294 to first identify a sign threshold, which may represent a threshold by which to set each bin of the various frequency bands to a common sign. For example, a frequency band may include a number of bins having predominantly the same sign (e.g., 8 out of 9 bins of the band are positive or negative in terms of the sign for the value of that bin). The theta/phi coder unit 294 may identify a sign count as a function sum of the signs of each bin in the band, comparing this sign count to the sign threshold so as to determine whether the sign for all of the bins should be set to a common sign (either positive or negative) or set to the signs of the bins of the corresponding band of the previous frame (and thereby reduce the amount of sign information that need be signaled or otherwise specified in the bitstream).

To illustrate, consider a band having nine bins, eight of which are positive and one of which are negative. The theta/phi coder unit 294 may determine the sign count as +8−1, which equals +7. Assuming the sign threshold is set to 6, the theta/phi coder unit 294 may compare the absolute value of the sign count to the threshold and determine that the bins of this frequency band should reset as a common sign. The theta/phi decoding unit 294 may then determine the sign of the sign count and use this determined sign as the sign for all of the bands, effectively resetting the bin with the negative sign to a positive sign. For another band, the theta/phi coder unit 294 may determine that the bins of that band have a sign count of +1. In this instance, when comparing the +1 sign count to the sign threshold of six, the theta/phi coder unit 294 may determine that this sign count does not exceed the sign threshold and therefore assign the signs from the band of the previous frame to the band of the current frame.

The theta/phi coder unit 294 may statically define this sign threshold or this sign threshold may be configured (or otherwise set by a user or other operator of the audio encoding device 20). Typically, a relatively higher sign threshold results in less sign changes, with the result that the corresponding ambient component of the soundfield appears to be less well directionally defined (and movement of this ambient component is potentially more perceptually obscured). A relatively lower sign threshold may result in more sign changes, with the ambient components of the soundfield appearing to be more directionally defined (and movement of this ambient component is potentially less perceptually obscured and, as a result, more apparent to a listener). However, generally the higher relative sign threshold provides a better listening experience given that the human auditory system is not very capable of identifying movement in ambient components. Any misrepresentations in the movement of the ambient component in the soundfield are often offset by the reduced number of artifacts, with the total effect being that the listener perceives the soundfield reproduced using a higher sign threshold as better than that reproduced using a relatively lower sign threshold.

The theta/phi coder unit 294 may perform this sign preservation on some bands to potentially reduce sign changes across frame boundaries and thereby possibly reduce the artifacts that result from these frame boundary sign changes. In some cases, such artifacts may include “clicking” noise at the frame boundaries, which may be reduced and in some cases eliminated, at least perceptively, by the techniques described herein. Moreover, the sign preservation techniques may promote more efficient signaling of sign information (in terms of using less bits through preservation of signs for bands across frame boundaries).

In other words, sign changes of quadrature mirror filter coefficients may be considered, where sign info may be determined for each time-frequency (T-F) band (band not only for frequency but also for time). If the majority of signs of a T-F band are positive (where the majority is defined by the sign threshold), the theta/phi coder unit 294 may determine the signs of all QMF coefficients for that T-F band as positive. If the majority of signs of a T-F band are negative (where again the majority is defined by the sign threshold), the theta/phi coder unit 294 may determine the signs of all QMF coefficients for that T-F band as negative. If no majority is identified (where again the majority or lack thereof is defined by the sign threshold), the theta/phi coder unit 294 may determine that the sign of the previous frame is to be used. The theta/phi coder unit 294 may generate sign information 304 that identifies the determined signs for each band. The theta/phi coder unit 294 may provide the sign information 298 along with the spatial information 296 to the bitstream generation unit 42, which may specify this sign information 298 along with the spatial information 296 in the bitstream 21.

In this respect, the techniques may enable a device for encoding audio data, such as the audio encoding device 20 to determine sign information when determining a spatial relationship between non-zero order higher-order ambisonic (HOA) coefficients associated with a spherical basis function having an order greater than zero with zero-order HOA coefficients associated with a basis function having a zero order.

In these and other examples, the audio encoding device 20 may be configured to determine a sign count based on a sign associated with each bin in a time-frequency band of a time-frequency version of the non-zero order HOA coefficients, and generate the sign information for the time-frequency band of the time-frequency version for the non-zero order HOA coefficients based on the sign count.

In these and other examples, the audio encoding device 20 may be configured to determine a sign count based on a sign associated with each bin in a time-frequency band of a time-frequency version of the non-zero order HOA coefficients, and when the sign count exceeds a sign threshold, generate the sign information to associate the time-frequency band of the time-frequency version for the non-zero order HOA coefficients with a sign of the sign count.

In these and other examples, the audio encoding device 20 may be configured to determine a sign count based on a sign associated with each bin in a time-frequency band of a time-frequency version of the non-zero order HOA coefficients, and when an absolute value the sign count exceeds a sign threshold, generate the sign information to associate the time-frequency band of the time-frequency version for the non-zero order HOA coefficients with a sign of the sign count.

In these and other examples, the audio encoding device 20 may be configured to determine a sign count based on a sign associated with each bin in a time-frequency band of a time-frequency version of the non-zero order HOA coefficients, and when an absolute value of the sign count exceeds a sign threshold and the sign count has a positive sign, generate the sign information to associate the time-frequency band of the time-frequency version for the non-zero order HOA coefficients with a positive sign.

In these and other examples, the audio encoding device 20 may be configured to determine a sign count based on a sign associated with each bin in a time-frequency band of a time-frequency version of the non-zero order HOA coefficients, and when an absolute value of the sign count exceeds a sign threshold and the sign count has a negative sign, generate the sign information to associate the time-frequency band of the time-frequency version for the non-zero order HOA coefficients with a negative sign.

In these and other examples, the audio encoding device 20 may be configured to determine a sign count based on a sign associated with each bin in a time-frequency band of a time-frequency version of the non-zero order HOA coefficients, and when an absolute value of the sign count does not exceed a sign threshold, generate the sign information to associate the time-frequency band of the time-frequency version for the non-zero order HOA coefficients of a current frame with sign information generated to associate a corresponding time-frequency band of the time-frequency version of the non-zero order HOA coefficients of a previous frame.

In these and other examples, the audio encoding device 20 may be configured to obtain spatial information for a spatial relation of the non-zero order HOA coefficients with the zero-order HOA coefficients, the spatial information resulting in an error between the first plurality of hierarchical elements and a signal model of the first plurality of hierarchical elements. In these and other examples, the spatial information comprises an elevation angle and an azimuth angle. In these and other examples, signal model of the non-zero order HOA coefficients represents at least one directional component of the non-zero order HOA coefficients in the spatial relation with the zero-order HOA coefficients.

In these and other examples, the audio encoding device 20 may be configured to determine an azimuth angle, θ, of the spatial information according to:

$$sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}}$$

wherein k represents a frequency bin of the plurality of frequency bins of an i^{th} frequency band B.

In these and other examples, the audio encoding device 20 may be configured to determine an elevation angle, Φ, of the spatial information according to:

$$sin {ϕ}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}}$$

wherein k represents a frequency bin of the plurality of frequency bins of an i^{th} frequency band B.

In these and other examples, the error comprises a mean-squared error, E, comprising:

$$E = {\sum }_{k = B ( i )}^{B ( i + 1 )} \{ {( {X}_{k} - {\hat{X}}_{k} )}^{2} + {( {Y}_{k} - {\hat{Y}}_{k} )}^{2} + {( {Z}_{k} - {\hat{Z}}_{k} )}^{2} \} ,$$

wherein \hat{X}, Ŷ, \hat{Z}, describe a signal model of the non-zero order HOA coefficients that represents at least one directional component of the non-zero order HOA coefficients in the spatial relation with the zero-order HOA coefficients.

In these and other examples, the audio encoding device 20 may be configured to obtain a quantized version of the X signal, \hat{X}, a quantized version of the Y signal, Ŷ, and a quantized version of the Z signal, \hat{Z}, according to:

\hat{X}=Ŵ cos θ cos φ signX; Ŷ=Ŵ sin θ cos φ signY; \hat{Z}=Ŵ sin φ signZ,

where Ŵ denotes a quantized version of the W signal, signX denotes the sign information for the quantized version of the X signal, signY denotes the sign information for the quantized version of the Y signal and the signZ denotes the sign information for the quantized version of the Z signal.

FIGS. 4A-4B are block diagrams each illustrating an example of the audio decoding device 24 of FIG. 2 in more detail. As shown in the examples of FIGS. 4A-4B, the audio decoding device 24 may include an extraction unit 72, a directionality-based reconstruction unit 90 and a vector-based reconstruction unit 92. Although described below, more information regarding the audio decoding device 24 and the various aspects of decompressing or otherwise decoding HOA coefficients is available in International Patent Application Publication No. WO 2014/194099, entitled “INTERPOLATION FOR DECOMPOSED REPRESENTATIONS OF A SOUND FIELD,” filed 29 May 2014.

The extraction unit 72 may represent a unit configured to receive the bitstream 21 and extract the various encoded versions (e.g., a directional-based encoded version or a vector-based encoded version) of the HOA coefficients 11. The extraction unit 72 may determine from the above noted syntax element indicative of whether the HOA coefficients 11 were encoded via the various direction-based or vector-based versions. When a directional-based encoding was performed, the extraction unit 72 may extract the directional-based version of the HOA coefficients 11 and the syntax elements associated with the encoded version (which is denoted as directional-based information 91), passing the directional based information 91 to the directional-based reconstruction unit 90. The directional-based reconstruction unit 90 may represent a unit configured to reconstruct the HOA coefficients in the form of HOA coefficients 11′ based on the directional-based information 91.

When the syntax element indicates that the HOA coefficients 11 were encoded using a vector-based synthesis, the extraction unit 72 may extract the coded foreground V[k] vectors 57 (which may include coded weights 57 and/or indices 63 or scalar quantized V-vectors), the encoded ambient HOA coefficients 59 and the corresponding audio objects 61 (which may also be referred to as the encoded nFG signals 61). The audio objects 61 each correspond to one of the vectors 57. The extraction unit 72 may pass the coded foreground V[k] vectors 57 to the V-vector reconstruction unit 74 and the encoded ambient HOA coefficients 59 along with the encoded nFG signals 61 to the psychoacoustic decoding unit 80.

The V-vector reconstruction unit 74 may represent a unit configured to reconstruct the V-vectors from the encoded foreground V[k] vectors 57. The V-vector reconstruction unit 74 may operate in a manner reciprocal to that of the quantization unit 52.

The psychoacoustic decoding unit 80 may operate in a manner reciprocal to the psychoacoustic audio coder unit 40 shown in the example of FIG. 3 so as to decode the encoded ambient HOA coefficients 59 and the encoded nFG signals 61 and thereby generate energy compensated ambient HOA coefficients 47′ and the interpolated nFG signals 49′ (which may also be referred to as interpolated nFG audio objects 49′). The psychoacoustic decoding unit 80 may pass the energy compensated ambient HOA coefficients 47′ to the fade unit 770 and the nFG signals 49′ to the foreground formulation unit 78.

In the example of FIG. 4B, the psychoacoustic decoding unit 80 may operate in a manner reciprocal to the psychoacoustic audio coding unit 40 shown in the example of FIG. 3B so as to decode the encoded ambient HOA coefficients 59 and the encoded nFG signals 61 and thereby generate energy compensated ambient HOA coefficients 47A′, which again may represent the zero order HOA channel (also known as the ‘W’ or omnidirectional channel) and the interpolated nFG signals 49′ (which may also be referred to as interpolated nFG audio objects 49′). The psychoacoustic decoding unit 80 may pass the energy compensated ambient HOA coefficients 47A′ to the theta/phi decoding unit 86 and the nFG signals 49′ to the foreground formulation unit 78.

The spatio-temporal interpolation unit 76 may operate in a manner similar to that described above with respect to the spatio-temporal interpolation unit 50. The spatio-temporal interpolation unit 76 may receive the reduced foreground V[k] vectors 55ₖ and perform the spatio-temporal interpolation with respect to the foreground V[k] vectors 55ₖ and the reduced foreground V[k−1] vectors 55ₖ₋₁ to generate interpolated foreground V[k] vectors 55ₖ″. The spatio-temporal interpolation unit 76 may forward the interpolated foreground V[k] vectors 55ₖ″ to the fade unit 770.

The extraction unit 72 may also output a signal 757 indicative of when one of the ambient HOA coefficients is in transition to fade unit 770, which may then determine which of the SHC_{BG} 47′ (where the SHC_{BG} 47′ may also be denoted as “ambient HOA channels 47′” or “ambient HOA coefficients 47′”) and the elements of the interpolated foreground V[k] vectors 55ₖ″ are to be either faded-in or faded-out. In some examples, the fade unit 770 may operate opposite with respect to each of the ambient HOA coefficients 47′ and the elements of the interpolated foreground V[k] vectors 55ₖ″. That is, the fade unit 770 may perform a fade-in or fade-out, or both a fade-in or fade-out with respect to corresponding one of the ambient HOA coefficients 47′, while performing a fade-in or fade-out or both a fade-in and a fade-out, with respect to the corresponding one of the elements of the interpolated foreground V[k] vectors 55ₖ″. The fade unit 770 may output adjusted ambient HOA coefficients 47″ to the HOA coefficient formulation unit 82 and adjusted foreground V[k] vectors 55ₖ′″ to the foreground formulation unit 78. In this respect, the fade unit 770 represents a unit configured to perform a fade operation with respect to various aspects of the HOA coefficients or derivatives thereof, e.g., in the form of the ambient HOA coefficients 47′ and the elements of the interpolated foreground V[k] vectors 55ₖ″.

The foreground formulation unit 78 may represent a unit configured to perform matrix multiplication with respect to the adjusted foreground V[k] vectors 55ₖ′″ and the interpolated nFG signals 49′ to generate the foreground HOA coefficients 65. In this respect, the foreground formulation unit 78 may combine the audio objects 49′ (which is another way by which to denote the interpolated nFG signals 49′) with the vectors 55ₖ′″ to reconstruct the foreground or, in other words, predominant aspects of the HOA coefficients 11′. The foreground formulation unit 78 may perform a matrix multiplication of the interpolated nFG signals 49′ by the adjusted foreground V[k] vectors 55ₖ′″.

In the example of FIG. 4B, the theta/phi decoding unit 86 represents a unit configured to obtain spatial information 296 defining a spatial relation of ambient HOA coefficients 47B′-47D′ (associated with a basis function having an order greater than zero) with the ambient HOA coefficients 47A′ (associated with a basis function having a zero order). The theta/phi decoding unit 86 may reconstruct the ambient HOA coefficients 47B′-47D′ based at least in part on the spatial information 296 and the ambient HOA coefficients 47A′. In some examples, the theta/phi decoding unit 86 may reconstruct the ambient HOA coefficients 47B′-47D′ based at least in part on the spatial information 296 and the ambient HOA coefficients 47A′ in accordance with the signaling model of equation A-1:

\hat{X}=W cos θ cos φ,Ŷ=W sin θ cos φ,\hat{Z}=W sin φ. (A-1)

The foregoing equation enables the theta/phi decoding unit 86 to obtain a quantized version of the X signal, \hat{X}, a quantized version of the Y signal, Ŷ, and a quantized version of the Z signal, \hat{Z}. The quantized versions of these signals may be denoted in the example of FIG. 4B as energy compensated ambient HOA coefficients 47′. The theta/phi decoding unit 86 may provide the energy compensated ambient HOA coefficients 47′ made up of ambient HOA coefficients 47A′ and ambient HOA coefficients 47B′-47D′ to the HOA coefficient formulation unit 82.

In some example, the theta/phi decoding unit 86 may reconstruct the ambient HOA coefficients 47B′-47D′ based at least in part on the spatial information 296, the sign information 298 and the ambient HOA coefficients 47A′ in accordance with the following signaling model:

\hat{X}=Ŵ cos θ cos φ signX,Ŷ=Ŵ sin θ cos φ signY,\hat{Z}=Ŵ sin φ signZ (A-5)

where Ŵ denotes a quantized version of the W signal (shown as energy compensated ambient HOA coefficients 47A′), signX denotes the sign information for the quantized version of the X signal, signY denotes the sign information for the quantized version of the Y signal and the signZ denotes the sign information for the quantized version of the Z signal. Collectively, signX, signY and signZ are represented in the example of FIG. 4B as sign information 298. Moreover, the spatial information 296 collectively represents the theta (θ) and phi (φ) for all of the time-frequency bands.

In some instances, the theta/phi decoding unit 86 may modify the above sign-based signaling model to mix in some portion of the zero-order ambient HOA coefficients (associated with a spherical basis function having an order of zero) 47A′ when reconstructing the energy compensated HOA coefficients 47B′-47D′ based on the spatial information 296 and the sign information 298. That is, the energy compensated HOA coefficients 47B′-47D′ may, when reconstructed in accordance with the above signaling models, may be too directional in nature and not sufficiently ambient, focusing too narrowly on the defined theta and phi.

To potentially provide a better overall representation of the soundfield, the theta/phi decoding unit 86 may mix add to each of the non-zero order HOA coefficients 47B′-47D′ (e.g., the X signal, the Y signal and the Z signal) a weighted version of the zero-order ambient HOA coefficients 47A′ (e.g., the W signal). In some instances, the theta/phi decoding unit 86 may perform this mix in accordance with the following equations:

\hat{X}=\sqrt{a}*\hat{X}+\sqrt{1−a}*\hat{W};

Ŷ=\sqrt{a}*Ŷ+\sqrt{1−a}*\hat{W};

\hat{Z}=\sqrt{a}*\hat{Z}+\sqrt{1−a}*\hat{W}.

The variable ‘a’ in the foregoing equations denotes a weight, which may be statically defined or configurable by a user or other operator of the audio decoding device 24. In some instances, the theta/phi decoding unit 86 may perform this mix in accordance with the following equations:

\hat{X}=a*\hat{X}+(1−a)*\hat{W};

Ŷ=a*Ŷ+(1−a)*\hat{W};

\hat{Z}=a*\hat{Z}+(1−a)*\hat{W}.

The variable ‘a’ in the foregoing equations denotes a weight, which may be statically defined or configurable by a user or other operator of the audio decoding device 24.

In other words, at least some of the HOA channels, including W, X, Y, Z are reproduced at the audio decoding device 24. The W channel may be perceptually coded with AAC or USAC, while the other channels are reconstructed with one or more theta/phi parameters. The channels reconstructed by theta/phi may have rather strong directivity. To make the sound present in a more ambient manner, the W channel may be added to or otherwise mixed with the other channels.

The HOA coefficient formulation unit 82 may represent a unit configured to combine the foreground HOA coefficients 65 to the adjusted ambient HOA coefficients 47″ so as to obtain the HOA coefficients 11′. The prime notation reflects that the HOA coefficients 11′ may be similar to but not the same as the HOA coefficients 11. The differences between the HOA coefficients 11 and 11′ may result from loss due to transmission over a lossy transmission medium, quantization or other lossy operations.

In this respect, the techniques may enable a device for decoding audio data, such as the audio decoding device 24, to obtain sign information for non-zero order higher-order ambisonic (HOA) coefficients associated with a spherical basis function having an order greater than zero when reconstructing the non-zero order HOA coefficients using a spatial relation between the non-zero order HOA coefficients and zero-order HOA coefficients associated with a spherical basis function having an order of zero.

In these and other examples, the audio decoding device 24 may be configured to parse the sign information from a bitstream that also includes the zero-order HOA coefficients.

In these and other examples, the audio decoding device 24 may be configured to obtain spatial information for the spatial relation of the non-zero order HOA coefficients with the zero-order HOA coefficients, the spatial information resulting in an error between the first plurality of hierarchical elements and a signal model of the first plurality of hierarchical elements. In these and other examples, the spatial information comprises an elevation angle and an azimuth angle. In these and other examples, the signal model of the non-zero order HOA coefficients represents at least one directional component of the non-zero order HOA coefficients in the spatial relation with the zero-order HOA coefficients.

In these and other examples, the audio decoding device 24 may be configured to obtain a quantized version of the X signal, \hat{X}, a quantized version of the Y signal, Ŷ, and a quantized version of the Z signal, \hat{Z}, according to:

\hat{X}=Ŵ cos θ cos φ signX,Ŷ=Ŵ sin θ cos φ signY,\hat{Z}=Ŵ sin φ signZ,

where Ŵ denotes a quantized version of the W signal, signX denotes the sign information for the quantized version of the X signal, signY denotes the sign information for the quantized version of the Y signal and the signZ denotes the sign information for the quantized version of the Z signal.

In these and other examples, the audio decoding device 24 may be configured to mix one or more of a quantized version of the X signal, a quantized version of the Y signal and a quantized version of the Z signal with a quantized version of the W signal.

In these and other examples, the audio decoding device 24 may be configured to mix the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=\sqrt{a}*\hat{X}+\sqrt{1−a}*\hat{W};

Ŷ=\sqrt{a}*Ŷ+\sqrt{1−a}*\hat{W};

\hat{Z}=\sqrt{a}*\hat{Z}+\sqrt{1−a}*\hat{W}.

where ‘a’ denotes a weight.

In these and other examples, the audio decoding device 24 may be configured to mix the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=a*\hat{X}+(1−a)*\hat{W};

Ŷ=a*Ŷ+(1−a)*\hat{W};

\hat{Z}=a*\hat{Z}+(1−a)*\hat{W}.

where ‘a’ denotes a weight.

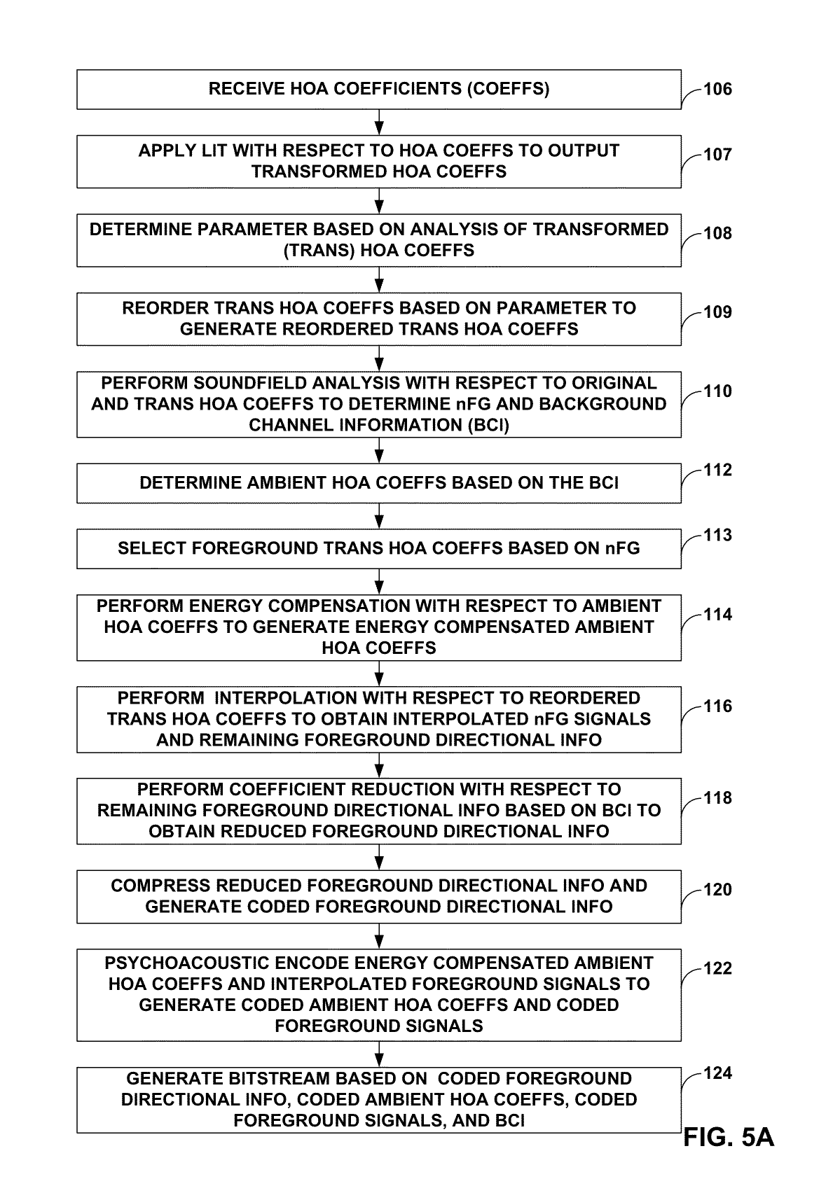

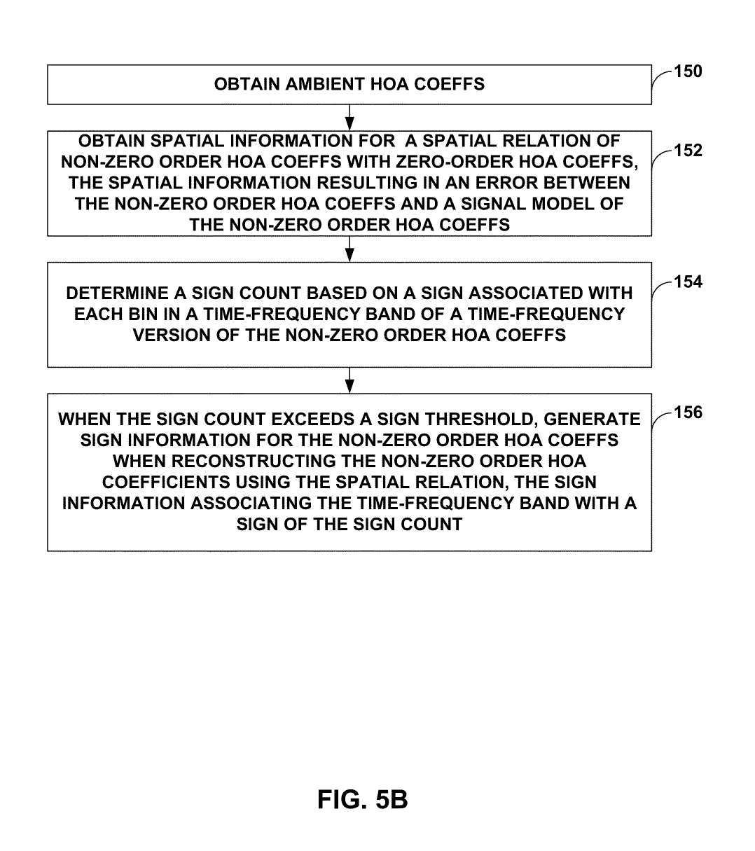

FIG. 5A is a flowchart illustrating exemplary operation of an audio encoding device, such as the audio encoding device 20 shown in the examples of FIGS. 3A-3B, in performing various aspects of the vector-based synthesis techniques described in this disclosure. Initially, the audio encoding device 20 receives the HOA coefficients 11 (106). The audio encoding device 20 may invoke the LIT unit 30, which may apply a LIT with respect to the HOA coefficients to output transformed HOA coefficients (e.g., in the case of SVD, the transformed HOA coefficients may comprise the US[k] vectors 33 and the V[k] vectors 35) (107).

The audio encoding device 20 may next invoke the parameter calculation unit 32 to perform the above described analysis with respect to any combination of the US[k] vectors 33, US[k−1] vectors 33, the V[k] and/or V[k−1] vectors 35 to identify various parameters in the manner described above. That is, the parameter calculation unit 32 may determine at least one parameter based on an analysis of the transformed HOA coefficients 33/35 (108).

The audio encoding device 20 may then invoke the reorder unit 34, which may reorder the transformed HOA coefficients (which, again in the context of SVD, may refer to the US[k] vectors 33 and the V[k] vectors 35) based on the parameter to generate reordered transformed HOA coefficients 33′/35′ (or, in other words, the US[k] vectors 33′ and the V[k] vectors 35′), as described above (109). The audio encoding device 20 may, during any of the foregoing operations or subsequent operations, also invoke the soundfield analysis unit 44. The soundfield analysis unit 44 may, as described above, perform a soundfield analysis with respect to the HOA coefficients 11 and/or the transformed HOA coefficients 33/35 to determine the total number of foreground channels (nFG) 45, the order of the background soundfield (N_{BG}) and the number (nBGa) and indices (i) of additional BG HOA channels to send (which may collectively be denoted as background channel information 43 in the example of FIG. 3) (109).

The audio encoding device 20 may also invoke the background selection unit 48. The background selection unit 48 may determine background or ambient HOA coefficients 47 based on the background channel information 43 (110). The audio encoding device 20 may further invoke the foreground selection unit 36, which may select the reordered US[k] vectors 33′ and the reordered V[k] vectors 35′ that represent foreground or distinct components of the soundfield based on nFG 45 (which may represent a one or more indices identifying the foreground vectors) (112).

The audio encoding device 20 may invoke the energy compensation unit 38. The energy compensation unit 38 may perform energy compensation with respect to the ambient HOA coefficients 47 to compensate for energy loss due to removal of various ones of the HOA coefficients by the background selection unit 48 (114) and thereby generate energy compensated ambient HOA coefficients 47′.

The audio encoding device 20 may also invoke the spatio-temporal interpolation unit 50. The spatio-temporal interpolation unit 50 may perform spatio-temporal interpolation with respect to the reordered transformed HOA coefficients 33′/35′ to obtain the interpolated foreground signals 49′ (which may also be referred to as the “interpolated nFG signals 49′”) and the remaining foreground directional information 53 (which may also be referred to as the “V[k] vectors 53”) (116). The audio encoding device 20 may then invoke the coefficient reduction unit 46. The coefficient reduction unit 46 may perform coefficient reduction with respect to the remaining foreground V[k] vectors 53 based on the background channel information 43 to obtain reduced foreground directional information 55 (which may also be referred to as the reduced foreground V[k] vectors 55) (118).

The audio encoding device 20 may then invoke the quantization unit 52 to compress, in the manner described above, the reduced foreground V[k] vectors 55 and generate coded foreground V[k] vectors 57 (120).

The audio encoding device 20 may also invoke the psychoacoustic audio coder unit 40. The psychoacoustic audio coder unit 40 may psychoacoustic code each vector of the energy compensated ambient HOA coefficients 47′ and the interpolated nFG signals 49′ to generate encoded ambient HOA coefficients 59 and encoded nFG signals 61. The audio encoding device may then invoke the bitstream generation unit 42. The bitstream generation unit 42 may generate the bitstream 21 based on the coded foreground directional information 57, the coded ambient HOA coefficients 59, the coded nFG signals 61 and the background channel information 43.

FIG. 5B is a flowchart illustrating exemplary operation of an audio decoding device in performing the coding techniques described in this disclosure. The audio decoding device 24 receives the HOA coefficients 11 (150). The audio decoding device 24 obtains spatial information for a spatial relation of non-zero order ones of the HOA coefficients 11 that are associated with a spherical basis function having an order greater than zero, with zero-order one of HOA coefficients 11 that are associated with a spherical basis function having an order of zero (152). The spatial information may result in an error between the non-zero order HOA coefficients 11 and a signal model of the non-zero order HOA coefficients 11 that represents at least one directional component of the non-zero order HOA coefficients 11 in the spatial relation with the zero-order HOA coefficients 11. The audio decoding device 24 additionally obtains sign information for the non-zero order HOA coefficients 11 for use in reconstructing the non-zero order HOA coefficients 11 using the spatial relation and determines a sign count based on a sign associated with each bin in a time-frequency band of a time-frequency version of the non-zero order HOA coefficients 11 (154). The audio decoding device 24, when the sign count exceeds a sign threshold (expressed as a ratio or value, e.g.), generates the sign information to associate each bin in the time-frequency band with a sign of the sign-count (156).

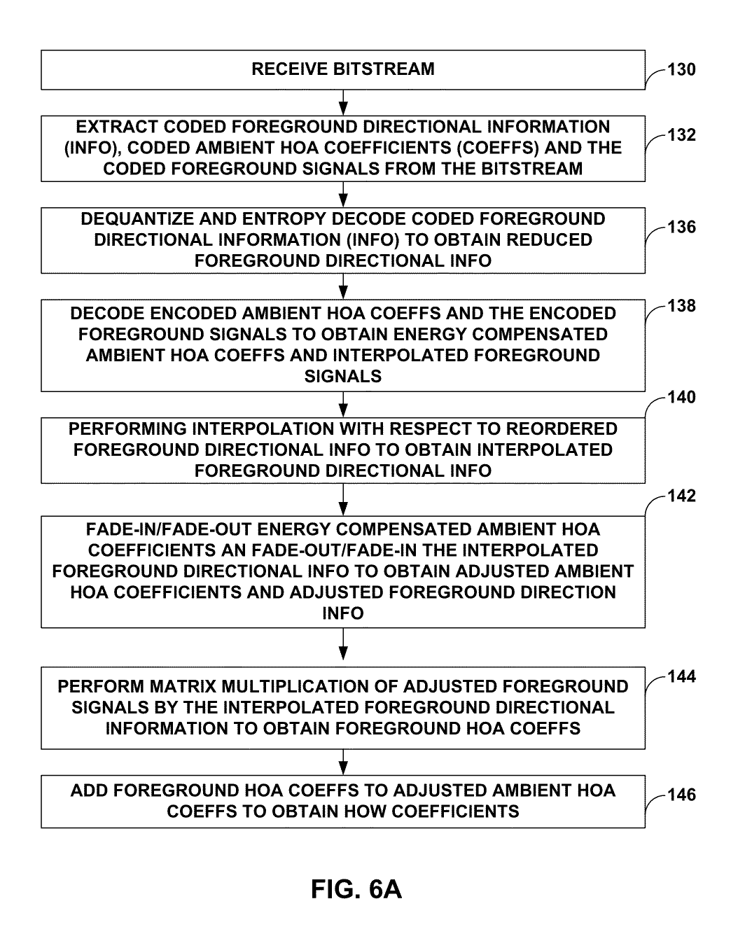

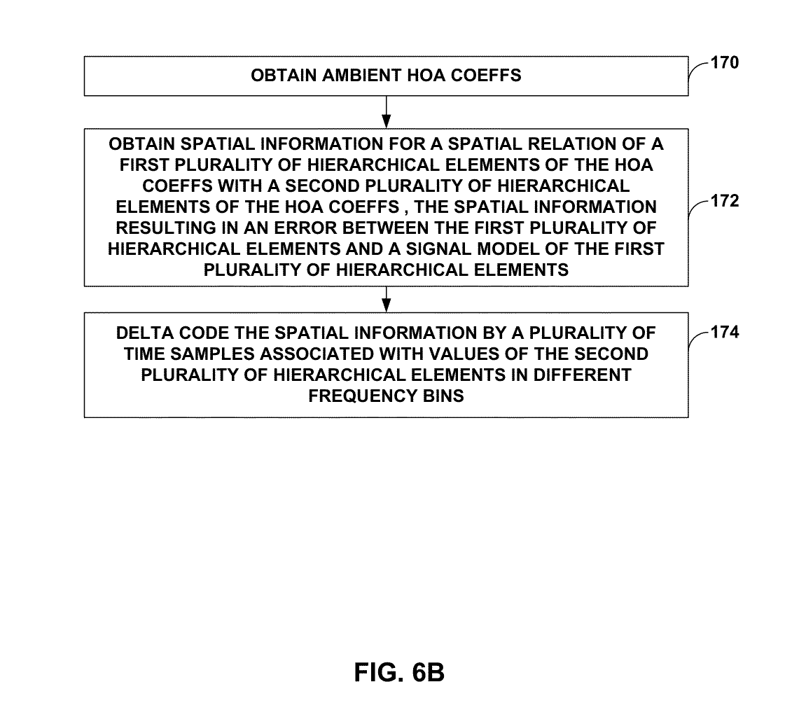

FIG. 6A is a flowchart illustrating exemplary operation of an audio decoding device, such as the audio decoding device 24 shown in FIGS. 4A-4B, in performing various aspects of the techniques described in this disclosure. Initially, the audio decoding device 24 may receive the bitstream 21 (130). Upon receiving the bitstream, the audio decoding device 24 may invoke the extraction unit 72. Assuming for purposes of discussion that the bitstream 21 indicates that vector-based reconstruction is to be performed, the extraction unit 72 may parse the bitstream to retrieve the above noted information, passing the information to the vector-based reconstruction unit 92.

In other words, the extraction unit 72 may extract the coded foreground directional information 57 (which, again, may also be referred to as the coded foreground V[k] vectors 57), the coded ambient HOA coefficients 59 and the coded foreground signals (which may also be referred to as the coded foreground nFG signals 59 or the coded foreground audio objects 59) from the bitstream 21 in the manner described above (132).

The audio decoding device 24 may further invoke the dequantization unit 74. The dequantization unit 74 may entropy decode and dequantize the coded foreground directional information 57 to obtain reduced foreground directional information 55ₖ (136). The audio decoding device 24 may also invoke the psychoacoustic decoding unit 80. The psychoacoustic audio decoding unit 80 may decode the encoded ambient HOA coefficients 59 and the encoded foreground signals 61 to obtain energy compensated ambient HOA coefficients 47′ and the interpolated foreground signals 49′ (138). The psychoacoustic decoding unit 80 may pass the energy compensated ambient HOA coefficients 47′ to the fade unit 770 and the nFG signals 49′ to the foreground formulation unit 78.

The audio decoding device 24 may next invoke the spatio-temporal interpolation unit 76. The spatio-temporal interpolation unit 76 may receive the reordered foreground directional information 55ₖ′ and perform the spatio-temporal interpolation with respect to the reduced foreground directional information 55ₖ/55ₖ₋₁ to generate the interpolated foreground directional information 55ₖ″ (140). The spatio-temporal interpolation unit 76 may forward the interpolated foreground V[k] vectors 55ₖ″ to the fade unit 770.

The audio decoding device 24 may invoke the fade unit 770. The fade unit 770 may receive or otherwise obtain syntax elements (e.g., from the extraction unit 72) indicative of when the energy compensated ambient HOA coefficients 47′ are in transition (e.g., the AmbCoeffTransition syntax element). The fade unit 770 may, based on the transition syntax elements and the maintained transition state information, fade-in or fade-out the energy compensated ambient HOA coefficients 47′ outputting adjusted ambient HOA coefficients 47″ to the HOA coefficient formulation unit 82. The fade unit 770 may also, based on the syntax elements and the maintained transition state information, and fade-out or fade-in the corresponding one or more elements of the interpolated foreground V[k] vectors 55ₖ″ outputting the adjusted foreground V[k] vectors 55ₖ′″ to the foreground formulation unit 78 (142).

The audio decoding device 24 may invoke the foreground formulation unit 78. The foreground formulation unit 78 may perform matrix multiplication the nFG signals 49′ by the adjusted foreground directional information 55ₖ′″ to obtain the foreground HOA coefficients 65 (144). The audio decoding device 24 may also invoke the HOA coefficient formulation unit 82. The HOA coefficient formulation unit 82 may add the foreground HOA coefficients 65 to adjusted ambient HOA coefficients 47″ so as to obtain the HOA coefficients 11′ (146).

FIG. 6B is a flowchart illustrating exemplary operation of an audio decoding device in performing the coding techniques described in this disclosure. The audio encoding device 20 receives the HOA coefficients 11 (170). The audio encoding device 20 obtains spatial information for a spatial relation of a first plurality of the HOA coefficients 11 that are associated with a spherical basis function having an order greater than zero, with a second plurality of the HOA coefficients 11 that are associated with a spherical basis function having an order of zero, where the HOA coefficients 11 represent just one example of a type of hierarchical elements (172). The spatial information may result in an error between the first plurality of the HOA coefficients 11 and a signal model of the first plurality of the HOA coefficients 11 that represents at least one directional component of the first plurality of the HOA coefficients 11 in the spatial relation with the second plurality of the HOA coefficients 11. The audio encoding device 20 may encode and transmit the spatial information and the W signal (or a quantized version thereof) as further described herein. In the example operation of FIG. 6B, the second plurality of hierarchical elements comprises values for a plurality of frequency bins at each of a plurality of time samples, and the audio encoding device 20 delta codes the spatial information by the plurality of time samples by allocating a larger number of bits for higher-frequency frequency bands than for lower-frequency bands (174).

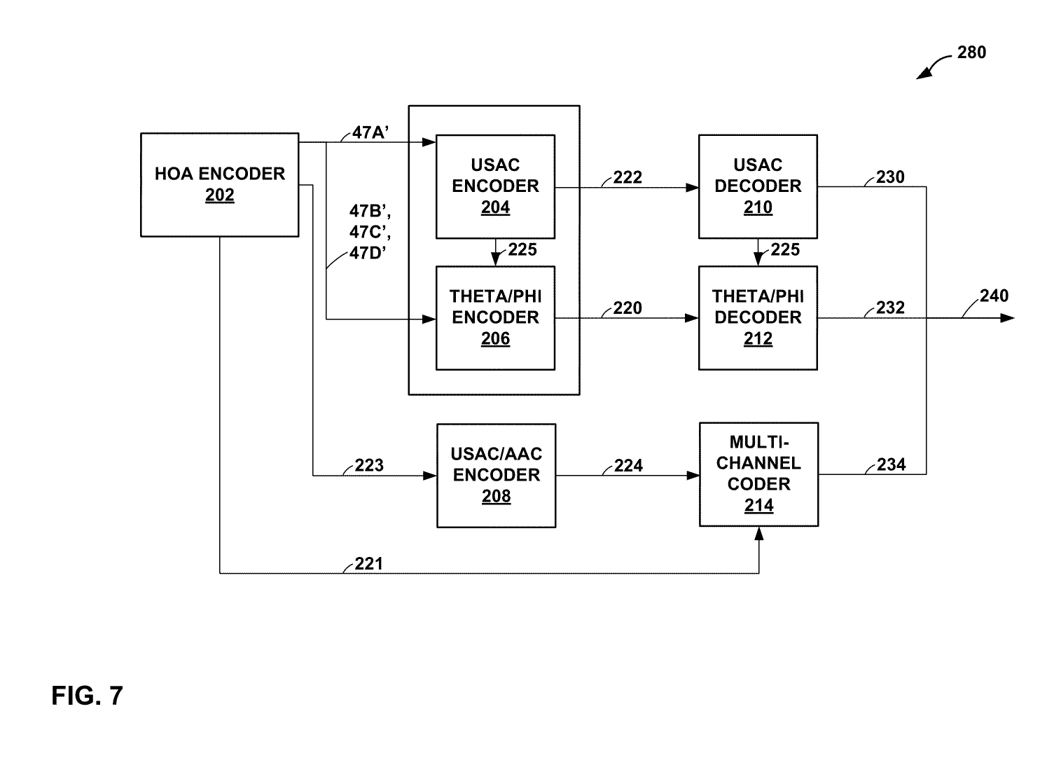

FIG. 7 is a block diagram illustrating example components for performing techniques according to this disclosure. Block diagram 280 illustrates example modules and signals for determining, encoding, transmitting, and decoding spatial information for directional components of SHC coefficients according to techniques described herein. The HOA encoder 206 may determine HOA coefficients 47A-47D′ (the W, X, Y, Z channels) and foreground HOA coefficients 223 as described above with respect to FIG. 3B. HOA coefficients 47A′-47D′ may represent a background or ambient portion of the soundfield, while foreground HOA coefficients 223 may include a foreground portion. In examples, HOA coefficients 47A′-47D′ include a 4-ch signal, while foreground HOA coefficients 223 represent a 2-ch signal. V-vector 221 is transmitted separately for multi-channel coder 214 to decode the multichannel HOA coefficients 234 (encoded by USAC/AAC encoder 208 and transmitted as encoded foreground HOA coefficients 224) from the V-vector 221 and foreground HOA coefficients 223). In some examples, multichannel HOA coefficients 234 is a 12-ch signal.

The Unified Speech and Audio Coding (USAC) encoder 204 determines the W′ signal 225 and provides W′ signal 225 to theta/phi encoder 206 for determining and encoding spatial relation information 220. USAC encoder 204 sends the W′ signal 22 to USAC decoder 210 as encoded W′ signal 222. USAC encoder and the spatial relation encoder 206 (“Theta/phi encoder 206”) may be example components of theta/phi coder unit 294 of FIG. 3B.

The USAC decoder 210 and theta/phi decoder 212 may determine quantized HOA coefficients 47A′-47D′ (the W, X, Y, Z channels) as described above with respect to FIG. 3B, based on the received encoded spatial relation information 222 and encoded W′ signal 222. Quantized W′ signal (HOA coefficients 47A′) 230, quantized HOA coefficients 47B′-47D′, and multichannel HOA coefficients 234 together make up quantized HOA coefficients 240 for rendering. Quantized HOA coefficients 240 may represent a 16-ch signal.

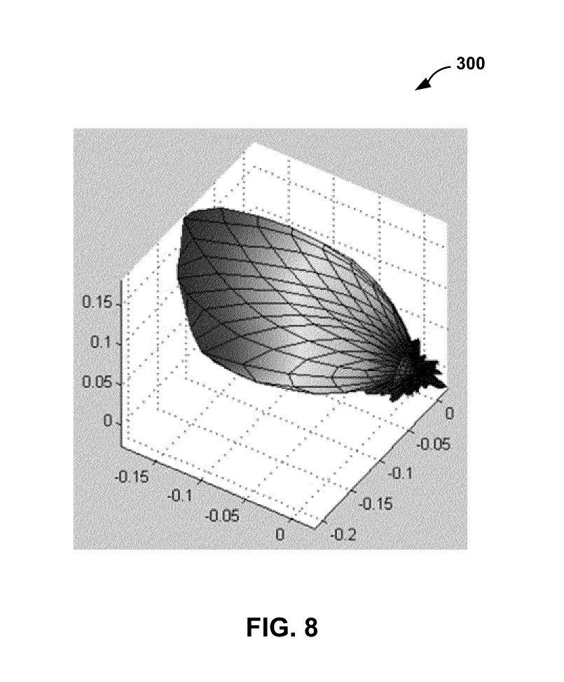

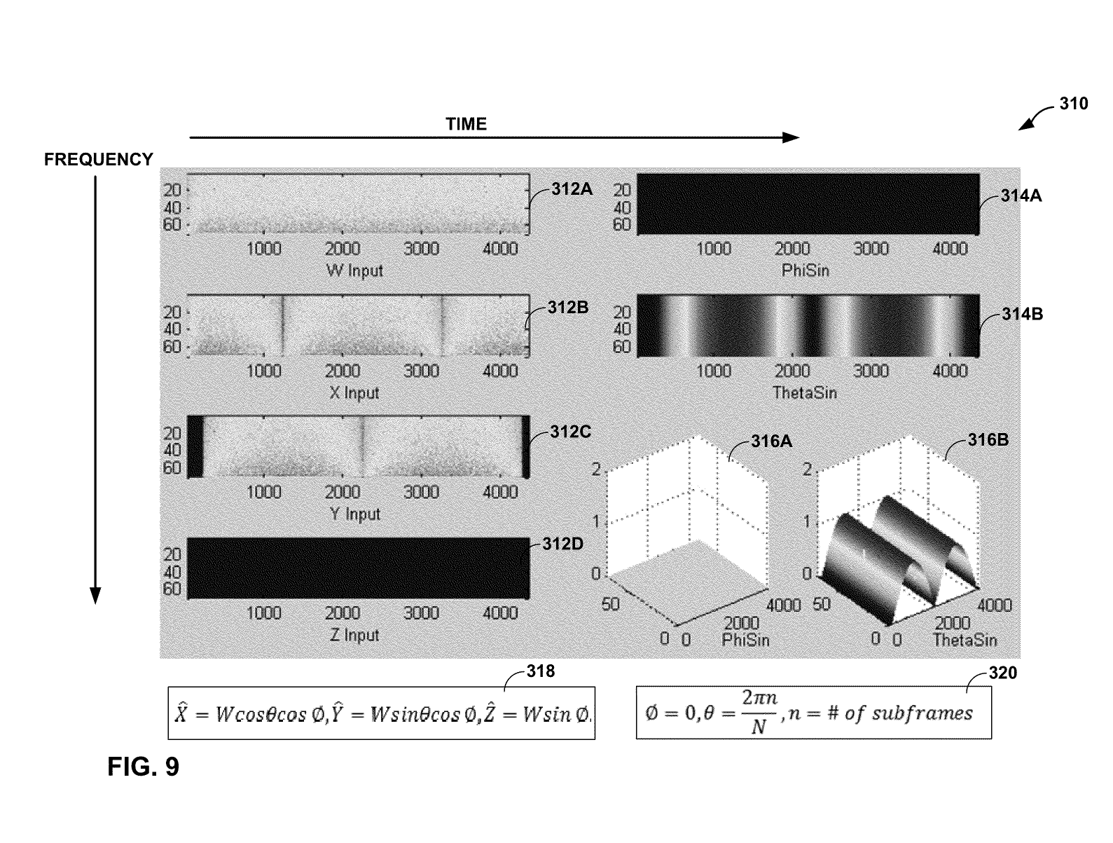

FIGS. 8-9 depict visualizations for example W, X, Y, and Z signal input spectrograms and spatial information generated according to techniques described in this disclosure. Example signals 312A-312D are generated according spatial information generated by equations 320 for multiple time and frequency bins, with signals 312A-312D generated using equation A-1, above. Maps 314A, 316A depict sin φ for equations 320 in 2 and 3 dimensions, respectively; while maps 314B, 316B depict sin θ for equations 320 in 2 and 3 dimensions, respectively.

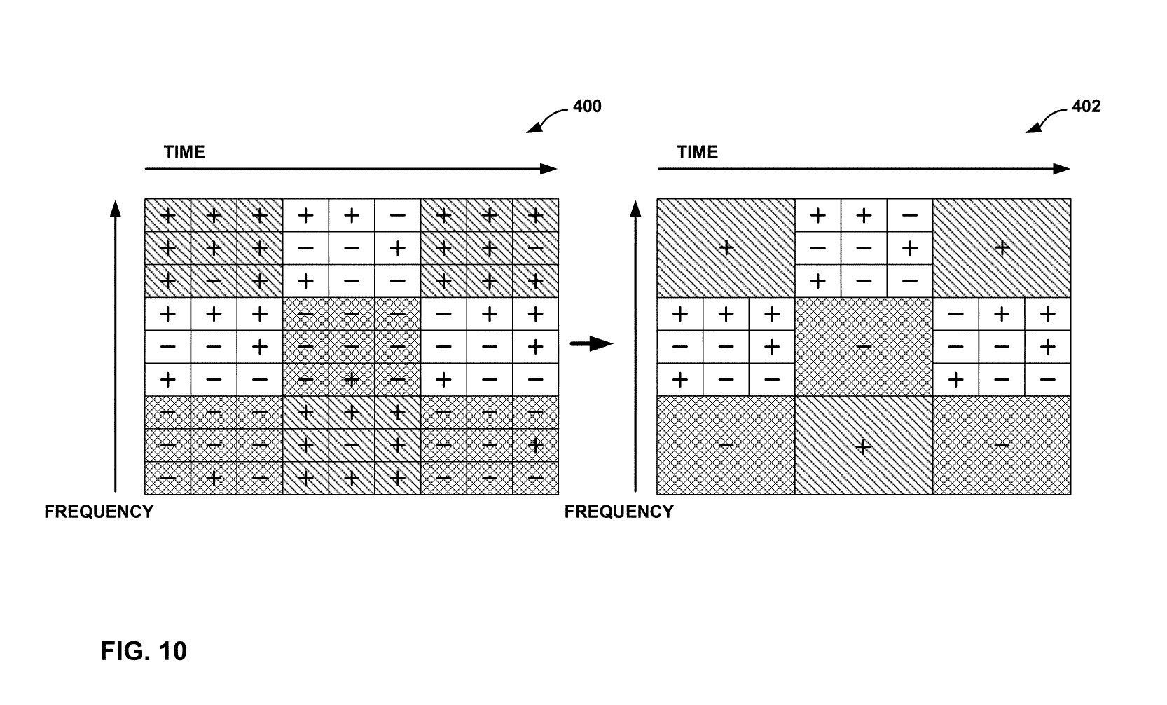

FIG. 10 is a conceptual diagram illustrating theta/phi encoding and decoding with the sign information aspects of the techniques described in this disclosure. In the example of FIG. 10, the theta/phi encoding unit 294 of the audio encoding device 20 shown in the example of FIG. 3B, e.g., may estimate the theta and phi in accordance (A-1)-(A-6) and synthesize the signals according to the following equations:

$$\begin{matrix}sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}} & ( B \text{-} 1 ) \\ sin {Ø}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}} & ( B \text{-} 1 )\end{matrix}$$

\hat{X}=Ŵ cos θ cos φ signX,Ŷ=Ŵ sin θ cos φ signY,\hat{Z}=Ŵ sin φ signZ (B-3)

signA=sign(cos(angle(W)−angle(A))) (B-4)

where Ŵ denotes a quantized version of the W signal (shown as energy compensated ambient HOA coefficients 47A′), signX denotes the sign information for the quantized version of the X signal, signY denotes the sign information for the quantized version of the Y signal and the signZ denotes the sign information for the quantized version of the Z signal.

The theta/phi encoding unit 294 may perform operations similar to those shown in the following pseudo-code to derive the sign information 298, although the pseudo-code may be modified to account for an integer SignThreshold (e.g., 6 or 4) rather than the ratio (e.g., 0.8 in the example pseudo-code) and the various operators may be understood to compute the sign count (which is the SignStacked variable) on a time-frequency band basis:

1. SignThreshold=0.8;

2. SignStacked(i)=sum(SignX(i));

3. tmpIdx=abs(SignStacked(i))<SignThreshold;

4. SignStacked(i, tmpIdx)=SignStacked(i−1, tmpIdx)

5. SignStacked(i, :)=sign(SignStacked(i, :)+eps)

The conceptual diagram of FIG. 10 further shows two sign maps 400 and 402, where, in both sign maps 400 and 402, the X-axis (left to right) denotes time and the Y-axis (down to up) denotes frequency. Both sign maps 400 and 402 include 9 frequency bands, denoted by the different patterns of blank, diagonal lines, and hash lines. The diagonal line bands of sign map 400 each include 9 predominantly positive signed bins. The blank bands of sign map 400 each include 9 mixed signed bins having approximately a +1 or −1 difference between positive signed bins and negative signed bins. The hash line bands of sign map 400 each include 9 predominantly negative signed bins.

Sign map 402 illustrates how the sign information is associated with each of the bands based on the example pseudo-code above. The theta/phi encoding unit 294 may determine that the predominantly positive signed diagonal line bands in the sign map 400 should be associated with sign information indicating that the bins for these diagonal line bands should be uniformly positive, which is shown in sign map 402. The blank bands in sign map 400 are neither predominantly positive nor negative and are associated with sign information for a corresponding band of a previous frame (which is unchanged in the example sign map 402). The theta/phi encoding unit 294 may determine that the predominantly negative signed hashed lines bands in the sign map 400 should be associated with sign information indicating that the bins for these hashed lines bands should be uniformly negative, which is shown in sign map 402, and encode such sign information accordingly for transmission with the bins.

The foregoing techniques may be performed with respect to any number of different contexts and audio ecosystems. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into the HOA coefficients for playback by one or more of the playback elements. For instance, a user of the mobile device may record (acquire a soundfield of) a live event (e.g., a meeting, a conference, a play, a concert, etc.), and code the recording into HOA coefficients.

The mobile device may also utilize one or more of the playback elements to playback the HOA coded soundfield. For instance, the mobile device may decode the HOA coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D soundfield and playback the same 3D soundfield at a later time. In some examples, the mobile device may acquire a 3D soundfield, encode the 3D soundfield into HOA, and transmit the encoded 3D soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of HOA signals. For instance, the one or more DAWs may include HOA plugins and/or tools which may be configured to operate with (e.g., work with) one or more game audio systems. In some examples, the game studios may output new stem formats that support HOA. In any case, the game studios may output coded audio content to the rendering engines which may render a soundfield for playback by the delivery systems.

The techniques may also be performed with respect to exemplary audio acquisition devices. For example, the techniques may be performed with respect to an Eigen microphone which may include a plurality of microphones that are collectively configured to record a 3D soundfield. In some examples, the plurality of microphones of Eigen microphone may be located on the surface of a substantially spherical ball with a radius of approximately 4 cm. In some examples, the audio encoding device 20 may be integrated into the Eigen microphone so as to output a bitstream 21 directly from the microphone.

Another exemplary audio acquisition context may include a production truck which may be configured to receive a signal from one or more microphones, such as one or more Eigen microphones. The production truck may also include an audio encoder, such as audio encoder 20 of FIGS. 3A-3B.

The mobile device may also, in some instances, include a plurality of microphones that are collectively configured to record a 3D soundfield. In other words, the plurality of microphone may have X, Y, Z diversity. In some examples, the mobile device may include a microphone which may be rotated to provide X, Y, Z diversity with respect to one or more other microphones of the mobile device. The mobile device may also include an audio encoder, such as audio encoder 20 of FIGS. 3A-3B.

A ruggedized video capture device may further be configured to record a 3D soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a 3D soundfield that represents the action all around the user (e.g., water crashing behind the user, another rafter speaking in front of the user, etc. . . . ).

The techniques may also be performed with respect to an accessory enhanced mobile device, which may be configured to record a 3D soundfield. In some examples, the mobile device may be similar to the mobile devices discussed above, with the addition of one or more accessories. For instance, an Eigen microphone may be attached to the above noted mobile device to form an accessory enhanced mobile device. In this way, the accessory enhanced mobile device may capture a higher quality version of the 3D soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a 3D soundfield. Moreover, in some examples, headphone playback devices may be coupled to a decoder 24 via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the 3D soundfield of the sports game may be acquired (e.g., one or more Eigen microphones may be placed in and/or around the baseball stadium), HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the audio encoding device 20 may perform a method or otherwise comprise means to perform each step of the method for which the audio encoding device 20 is configured to perform In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio encoding device 20 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the audio decoding device 24 may perform a method or otherwise comprise means to perform each step of the method for which the audio decoding device 24 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio decoding device 24 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

In addition to or as an alternative to the above, the following examples are described. The features described in any of the following examples may be utilized with any of the other examples described herein.

Clause 1: A method for coding audio data, the method comprising obtaining spatial information for a spatial relation of a first plurality of hierarchical elements associated with a basis function having an order greater than zero with a second plurality of hierarchical elements associated with a basis function having a zero order, the spatial information resulting in an error between the first plurality of hierarchical elements and a signal model of the first plurality of hierarchical elements.

Clause 2: The method of clause 1, wherein the spatial information comprises an elevation angle and an azimuth angle.

Clause 3: The method of clause 1, wherein the signal model of the first plurality of hierarchical elements represents at least one directional component of the first plurality of hierarchical elements in the spatial relation with the second plurality of hierarchical elements.

Clause 4: The method of clause 1, wherein the first plurality of hierarchical elements comprises an X signal, a Y signal, and a Z signal, and wherein the second plurality of hierarchical elements comprises a W signal.

Clause 5: The method of clause 4, wherein the W signal comprises a quantized form of an original W signal.

Clause 6: The method of clause 4, wherein the W signal comprises a power sum of each of the X signal, the Y signal, and the Z signal in the same order.

Clause 7: The method of clause 1, wherein the first plurality of hierarchical elements comprises an X signal, a Y signal, and a Z signal, each of the X signal, Y signal, and Y signal comprising values for a plurality of frequency bins at a time, and wherein the second plurality of hierarchical elements comprises a W signal, the W signal comprising values for a plurality of frequency bins at the time.

Clause 8: The method of clause 7, further comprising determining an azimuth angle, θ, of the spatial information according to:

$$sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}}$$

wherein k represents a frequency bin of the plurality of frequency bins of an i^{th} frequency band B.

Clause 9: The method of clause 7, further comprising determining an elevation angle, Φ, of the spatial information according to:

$$sin {Ø}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}}$$

wherein k represents a frequency bin of the plurality of frequency bins of an i^{th} frequency band B.

Clause 10: The method of clause 7, wherein the error comprises a mean-squared error, E, comprising:

$$E = {\sum }_{k = B ( i )}^{B ( i + 1 )} \{ {( {X}_{k} - {\hat{X}}_{k} )}^{2} + {( {Y}_{k} - {\hat{Y}}_{k} )}^{2} + {( {Z}_{k} - {\hat{Z}}_{k} )}^{2} \} ,$$

wherein \hat{X}, Ŷ, \hat{Z}, describe a signal model of the first plurality of hierarchical elements that represents at least one directional component of the first plurality of hierarchical elements in the spatial relation with the second plurality of hierarchical elements.

Clause 10: The method of clause 7, wherein the spatial information comprises an elevation angle, Φ, and an azimuth angle, θ, the method further comprising obtaining a quantized version of the X signal, \hat{X}, a quantized version of the Y signal, Ŷ, and a quantized version of the Z signal, \hat{Z}, according to:

\hat{X}=W cos θ cos Ø,Ŷ=W sin θ cos Ø,\hat{Z}=W sin Ø.

Clause 11: The method of clause 7, wherein the plurality of hierarchical elements associated with the order greater than zero comprise a first plurality of HOA coefficients, wherein the plurality of hierarchical elements associated with the zero order comprise a second plurality of HOA coefficients, and wherein the basis function having an order greater than zero and the basis function having the zero order are spherical basis functions.

Clause 12: The method of clause 1, further comprising: retrieving a bitstream that includes encoded audio data comprising the plurality of hierarchical elements associated with the zero order and the spatial information; parsing the encoded audio data from the bitstream to obtain the spatial information; and decoding the parsed encoded audio data to generate the second plurality of hierarchical elements.

Clause 13: The method of clause 1, further comprising: retrieving a bitstream that includes encoded audio data and the spatial information; parsing the encoded audio data from the bitstream, wherein obtaining the spatial information comprises parsing the spatial information from the bitstream; and decoding the parsed encoded audio data in accordance with an audio coding scheme and the spatial information to obtain a quantized version of the first plurality of hierarchical elements.

Clause 14: The method of clause 13, wherein the audio coding scheme comprises advanced audio coding (AAC).

Clause 15: The method of clause 1, wherein the second plurality of hierarchical elements comprises values for a plurality of frequency bins at each of a plurality of time samples, the method further comprising: delta coding the spatial information by the plurality of time samples.

Clause 16: The method of clause 15, wherein delta coding the spatial information comprises allocating a larger number of bits for higher-frequency frequency bands than for lower-frequency bands.

Clause 17: A device comprising one or more processors configured to perform any of clauses 1-16.

Clause 18: A device comprising means for performing any of clauses 1-16.

Clause 19: A computer-readable storage medium having stored thereon instructions that, when executed, cause one or more processors to perform any of clauses 1-16.

Clause 20: A computer-readable storage medium having stored thereon instructions that, when executed, cause one or more processors to obtain, by a coder, spatial information for a spatial relation of a first plurality of hierarchical elements associated with an order greater than zero with a second plurality of hierarchical elements associated with a zero order, the spatial information resulting in an error between the first plurality of hierarchical elements and a signal model of the first plurality of hierarchical elements.

Clause 21: The non-transitory computer-readable storage medium of clause 20, wherein the coder comprises one of an encoder and a decoder.

Clause 22: A method for decoding audio data, the method comprising obtaining spatial information for a spatial relation of a first plurality of hierarchical elements associated with a basis function having an order greater than zero with a second plurality of hierarchical elements associated with a basis function having a zero order, the spatial information resulting in an error between the first plurality of hierarchical elements and a signal model of the first plurality of hierarchical elements.

Clause 23: The method of clause 22, wherein the spatial information comprises an elevation angle and an azimuth angle.

Clause 24: The method of clause 22, wherein the signal model of the first plurality of hierarchical elements represents at least one directional component of the first plurality of hierarchical elements in the spatial relation with the second plurality of hierarchical elements.

Clause 25: The method of clause 22, wherein the first plurality of hierarchical elements comprises an X signal, a Y signal, and a Z signal, and wherein the second plurality of hierarchical elements comprises a W signal.

Clause 26: The method of clause 25, wherein the W signal comprises a quantized form of an original W signal.

Clause 27: The method of clause 25, wherein the W signal comprises a power sum of each of the X signal, the Y signal, and the Z signal in the same order.

Clause 28: The method of clause 22, wherein the first plurality of hierarchical elements comprises an X signal, a Y signal, and a Z signal, each of the X signal, Y signal, and Y signal comprising values for a plurality of frequency bins at a time, and wherein the second plurality of hierarchical elements comprises a W signal, the W signal comprising values for a plurality of frequency bins at the time.

Clause 29: The method of clause 28, wherein the spatial information comprises an elevation angle, Φ, and an azimuth angle, θ, the method further comprising obtaining a quantized version of the X signal, \hat{X}, a quantized version of the Y signal, Ŷ, and a quantized version of the Z signal, \hat{Z}, according to:

\hat{X}=W cos θ cos Ø,Ŷ=W sin θ cos Ø,\hat{Z}=W sin Ø.

Clause 30: The method of clause 22, wherein the first plurality of hierarchical elements comprises an X signal, a Y signal, and a Z signal, each of the X signal, Y signal, and Y signal comprising values for a plurality of frequency bins at a time, wherein the second plurality of hierarchical elements comprises a W signal, the W signal comprising values for a plurality of frequency bins at the time, and wherein the method further comprises mixing one or more of a quantized version of the X signal, a quantized version of the Y signal and a quantized version of the Z signal with a quantized version of the W signal.

Clause 31: The method of clause 30, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=\sqrt{a}*\hat{X}+\sqrt{1−a}*\hat{W};

Ŷ=\sqrt{a}*Ŷ+\sqrt{1−a}*\hat{W};

\hat{Z}=\sqrt{a}*\hat{Z}+\sqrt{1−a}*\hat{W}.

where ‘a’ denotes a weight.

Clause 32: The method of clause 30, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=a*\hat{X}+(1−a)*\hat{W};

Ŷ=a*Ŷ+(1−a)*\hat{W};

\hat{Z}=a*\hat{Z}+(1−a)*\hat{W}.

where ‘a’ denotes a weight.

Clause 33: The method of clause 22, wherein the plurality of hierarchical elements associated with the order greater than zero comprise a first plurality of HOA coefficients, wherein the plurality of hierarchical elements associated with the zero order comprise a second plurality of HOA coefficients, and wherein the basis function having an order greater than zero and the basis function having the zero order are spherical basis functions.

Clause 34: The method of clause 22, further comprising: retrieving a bitstream that includes encoded audio data comprising the plurality of hierarchical elements associated with the zero order and the spatial information; parsing the encoded audio data from the bitstream to obtain the spatial information; and decoding the parsed encoded audio data to generate the second plurality of hierarchical elements.

Clause 35: The method of clause 22, further comprising: retrieving a bitstream that includes encoded audio data and the spatial information; parsing the encoded audio data from the bitstream, wherein obtaining the spatial information comprises parsing the spatial information from the bitstream; and decoding the parsed encoded audio data in accordance with an audio coding scheme and the spatial information to obtain a quantized version of the first plurality of hierarchical elements.

Clause 36: The method of clause 35, wherein the audio coding scheme comprises advanced audio coding (AAC).

Clause 37: The method of clause 22, wherein the second plurality of hierarchical elements comprises values for a plurality of frequency bins at each of a plurality of time samples, the method further comprising: delta coding the spatial information by the plurality of time samples.

Clause 38: The method of clause 37, wherein the spatial information comprises a larger number of bits for higher-frequency frequency bands than for lower-frequency bands.

Clause 39: A device comprising one or more processors configured to perform any of clauses 22-38.

Clause 40: A device comprising means for performing any of clauses 22-38.

Clause 41: A computer-readable storage medium having stored thereon instructions that, when executed, cause one or more processors to perform any of clauses 22-38.

Clause 42: A method for decoding audio data, the method comprising obtaining sign information for non-zero order higher-order ambisonic (HOA) coefficients associated with a spherical basis function having an order greater than zero when reconstructing the non-zero order HOA coefficients using a spatial relation between the non-zero order HOA coefficients and zero-order HOA coefficients associated with a spherical basis function having an order of zero.

Clause 43: The method of clause 42, wherein obtaining the sign information comprises parsing the sign information from a bitstream that also includes the zero-order HOA coefficients.

Clause 44: The method of clause 42, further comprising obtaining spatial information for the spatial relation of the non-zero order HOA coefficients with the zero-order HOA coefficients, the spatial information resulting in an error between the first plurality of hierarchical elements and a signal model of the first plurality of hierarchical elements.

Clause 45: The method of clause 44, wherein the spatial information comprises an elevation angle and an azimuth angle.

Clause 46: The method of clause 44, wherein the signal model of the non-zero order HOA coefficients represents at least one directional component of the non-zero order HOA coefficients in the spatial relation with the zero-order HOA coefficients.

Clause 47: The method of clause 44, wherein the non-zero order HOA coefficients comprise an X signal, a Y signal, and a Z signal, and wherein the zero-order HOA coefficients comprise a W signal.

Clause 48: The method of clause 47, wherein the W signal comprises a quantized form of an original W signal.

Clause 49: The method of clause 47, wherein the W signal comprises a power sum of each of the X signal, the Y signal, and the Z signal in the same order.

Clause 50: The method of clause 44, wherein the non-zero order HOA coefficients comprise an X signal, a Y signal, and a Z signal, each of the X signal, Y signal, and Y signal comprising values for a plurality of frequency bins at a time, and wherein the zero-order HOA coefficients comprise a W signal, the W signal comprising values for a plurality of frequency bins at the time.

Clause 51: The method of clause 44, wherein the spatial information comprises an elevation angle, φ, and an azimuth angle, θ, the method further comprising: obtaining a quantized version of the X signal, \hat{X}, a quantized version of the Y signal, Ŷ, and a quantized version of the Z signal, \hat{Z}, according to:

\hat{X}=Ŵ cos θ cos φ signX,Ŷ=Ŵ sin θ cos φ signY,\hat{Z}=Ŵ sin φ signZ,

where Ŵ denotes a quantized version of the W signal, signX denotes the sign information for the quantized version of the X signal, signY denotes the sign information for the quantized version of the Y signal and the signZ denotes the sign information for the quantized version of the Z signal.

Clause 52: The method of clause 44, wherein the first plurality of hierarchical elements comprises an X signal, a Y signal, and a Z signal, each of the X signal, Y signal, and Y signal comprising values for a plurality of frequency bins at a time, wherein the second plurality of hierarchical elements comprises a W signal, the W signal comprising values for a plurality of frequency bins at the time, wherein the method further comprises mixing one or more of a quantized version of the X signal, a quantized version of the Y signal and a quantized version of the Z signal with a quantized version of the W signal.

Clause 53: The method of clause 52, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=\sqrt{a}*\hat{X}+\sqrt{1−a}*\hat{W};

Ŷ=\sqrt{a}*Ŷ+\sqrt{1−a}*\hat{W};

\hat{Z}=\sqrt{a}*\hat{Z}+\sqrt{1−a}*\hat{W}.

where ‘a’ denotes a weight.

Clause 54: The method of clause 52, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:

\hat{X}=a*\hat{X}+(1−a)*\hat{W};

Ŷ=a*Ŷ+(1−a)*\hat{W};

\hat{Z}=a*\hat{Z}+(1−a)*\hat{W}.

where ‘a’ denotes a weight.

Clause 55: A device comprising one or more processors configured to perform any of clauses 42-54.

Clause 56: A device comprising means for performing any of clauses 42-54.

Clause 57: A computer-readable storage medium having stored thereon instructions that, when executed, cause one or more processors to perform any of clauses 42-54.

Clause 58: A method for encoding audio data, the method comprising determining sign information when determining a spatial relationship between non-zero order higher-order ambisonic (HOA) coefficients associated with a spherical basis function having an order greater than zero with zero-order HOA coefficients associated with a basis function having a zero order.

Clause 59: The method of clause 58, wherein determining the sign information comprises: determining a sign count based on a sign associated with each bin in a time-frequency band of a time-frequency version of the non-zero order HOA coefficients; and generating the sign information for the time-frequency band of the time-frequency version for the non-zero order HOA coefficients based on the sign count.

Clause 60: The method of clause 58, wherein determining the sign information comprises: determining a sign count based on a sign associated with each bin in a time-frequency band of a time-frequency version of the non-zero order HOA coefficients; and when the sign count exceeds a sign threshold, generating the sign information to associate the time-frequency band of the time-frequency version for the non-zero order HOA coefficients with a sign of the sign count.

Clause 61: The method of clause 58, wherein determining the sign information comprises: determining a sign count based on a sign associated with each bin in a time-frequency band of a time-frequency version of the non-zero order HOA coefficients; and when an absolute value the sign count exceeds a sign threshold, generating the sign information to associate the time-frequency band of the time-frequency version for the non-zero order HOA coefficients with a sign of the sign count.

Clause 62: The method of clause 58, wherein determining the sign information comprises: determining a sign count based on a sign associated with each bin in a time-frequency band of a time-frequency version of the non-zero order HOA coefficients; and when an absolute value of the sign count exceeds a sign threshold and the sign count has a positive sign, generating the sign information to associate the time-frequency band of the time-frequency version for the non-zero order HOA coefficients with a positive sign.

Clause 63: The method of clause 58, wherein determining the sign information comprises: determining a sign count based on a sign associated with each bin in a time-frequency band of a time-frequency version of the non-zero order HOA coefficients; and when an absolute value of the sign count exceeds a sign threshold and the sign count has a negative sign, generating the sign information to associate the time-frequency band of the time-frequency version for the non-zero order HOA coefficients with a negative sign.

Clause 64: The method of clause 58, wherein determining the sign information comprises: determining a sign count based on a sign associated with each bin in a time-frequency band of a time-frequency version of the non-zero order HOA coefficients; and when an absolute value of the sign count does not exceed a sign threshold, generating the sign information to associate the time-frequency band of the time-frequency version for the non-zero order HOA coefficients of a current frame with sign information generated to associate a corresponding time-frequency band of the time-frequency version of the non-zero order HOA coefficients of a previous frame.

Clause 65: The method of clause 58, further comprising: obtaining spatial information for a spatial relation of the non-zero order HOA coefficients with the zero-order HOA coefficients, the spatial information resulting in an error between the first plurality of hierarchical elements and a signal model of the first plurality of hierarchical elements.

Clause 66: The method of clause 65, wherein the spatial information comprises an elevation angle and an azimuth angle.

Clause 67: The method of clause 65, wherein the signal model of the non-zero order HOA coefficients represents at least one directional component of the non-zero order HOA coefficients in the spatial relation with the zero-order HOA coefficients.

Clause 68: The method of clause 65, wherein the non-zero order HOA coefficients comprise an X signal, a Y signal, and a Z signal, and wherein the zero-order HOA coefficients comprise a W signal.

Clause 70: The method of clause 68, wherein the W signal comprises a quantized form of an original W signal.

Clause 71: The method of clause 68, wherein the W signal comprises a power sum of each of the X signal, the Y signal, and the Z signal in the same order.

Clause 72: The method of clause 65, wherein the non-zero order HOA coefficients comprise an X signal, a Y signal, and a Z signal, each of the X signal, Y signal, and Y signal comprising values for a plurality of frequency bins at a time, and wherein the zero-order HOA coefficients comprise a W signal, the W signal comprising values for a plurality of frequency bins at the time.

Clause 73: The method of clause 72, further comprising determining an azimuth angle, θ, of the spatial information according to:

$$sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}}$$

wherein k represents a frequency bin of the plurality of frequency bins of an i^{th} frequency band B.

Clause 74: The method of clause 72, further comprising determining an elevation angle, Φ, of the spatial information according to:

$$sin {Ø}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}}$$

wherein k represents a frequency bin of the plurality of frequency bins of an i^{th} frequency band B.

Clause 75: The method of clause 72, wherein the error comprises a mean-squared error, E, comprising:

$$E = {\sum }_{k = B ( i )}^{B ( i + 1 )} \{ {( {X}_{k} - {\hat{X}}_{k} )}^{2} + {( {Y}_{k} - {\hat{Y}}_{k} )}^{2} + {( {Z}_{k} - {\hat{Z}}_{k} )}^{2} \} ,$$

wherein \hat{X}, Ŷ, \hat{Z}, describe a signal model of the non-zero order HOA coefficients that represents at least one directional component of the non-zero order HOA coefficients in the spatial relation with the zero-order HOA coefficients.

Clause 76: The method of clause 72, wherein the spatial information comprises an elevation angle, φ, and an azimuth angle, θ, the method further comprising obtaining a quantized version of the X signal, \hat{X}, a quantized version of the Y signal, Ŷ, and a quantized version of the Z signal, \hat{Z}, according to:

\hat{X}=Ŵ cos θ cos φ signX,Ŷ=Ŵ sin θ cos φ signY,Ŵ sin φ signZ,

where Ŵ denotes a quantized version of the W signal, signX denotes the sign information for the quantized version of the X signal, signY denotes the sign information for the quantized version of the Y signal and the signZ denotes the sign information for the quantized version of the Z signal.

Clause 77: A device comprising one or more processors configured to perform any of clauses 58-76.

Clause 78: A device comprising means for performing any of clauses 58-76.

Clause 79: A computer-readable storage medium having stored thereon instructions that, when executed, cause one or more processors to perform any of clauses 58-76.

Moreover, any of the specific features set forth in any of the examples described above may be combined into beneficial examples of the described techniques. That is, any of the specific features are generally applicable to all examples of the invention. Various examples of the invention have been described.

Various aspects of the techniques have been described. These and other aspects of the techniques are within the scope of the following claims.

What is claimed is:

1. A device for decoding audio data, the device comprising:
a memory to store the audio data; and
one or more processors coupled to the memory and configured to obtain spatial information for a spatial relation of:
non-zero order higher-order ambisonic (HOA) coefficients associated with a spherical basis function having an order greater than zero, with
zero-order HOA coefficients associated with a spherical basis function having an order of zero,
the spatial information resulting in an error between the non-zero order HOA coefficients and a signal model of the non-zero order HOA coefficients that represents at least one directional component of the non-zero order HOA coefficients in the spatial relation with the zero-order HOA coefficients,
wherein the one or more processors are further configured to obtain sign information for the non-zero order HOA coefficients when reconstructing the non-zero order HOA coefficients using the spatial relation.

2. The device of claim 1, wherein the one or more processors are configured to parse the sign information from a bitstream that also includes the zero-order HOA coefficients.

3. The device of claim 1,
wherein the non-zero order HOA coefficients comprise an X signal, a Y signal, and a Z signal, each of the X signal, Y signal, and Y signal comprising values for a plurality of frequency bins at a time, and
wherein the zero-order HOA coefficients comprise a W signal, the W signal comprising values for a plurality of frequency bins at the time.

4. The device of claim 1,
wherein the non-zero order HOA coefficients comprise an X signal, a Y signal, and a Z signal, each of the X signal, Y signal, and Y signal comprising values for a plurality of frequency bins at a time,
wherein the zero order HOA coefficients comprise a W signal, the W signal comprising values for a plurality of frequency bins at the time, and
wherein the one or more processors are configured to mix one or more of a quantized version of the X signal, a quantized version of the Y signal and a quantized version of the Z signal with a quantized version of the W signal.

5. The device of claim 1, wherein the one or more processors are configured to:
determine a sign count based on a sign associated with each bin in a time-frequency band of a time-frequency version of the non-zero order HOA coefficients; and
generate the sign information for the time-frequency band of the time-frequency version for the non-zero order HOA coefficients based on the sign count.

6. The device of claim 1, wherein the one or more processors are configured to:
determine a sign count based on a sign associated with each bin in a time-frequency band of a time-frequency version of the non-zero order HOA coefficients; and
when the sign count exceeds a sign threshold, generate the sign information to associate the time-frequency band of the time-frequency version for the non-zero order HOA coefficients with a sign of the sign count.

7. The device of claim 1, wherein the one or more processors are configured to:
determine a sign count based on a sign associated with each bin in a time-frequency band of a time-frequency version of the non-zero order HOA coefficients, and when an absolute value the sign count exceeds a sign threshold; and
generate the sign information to associate the time-frequency band of the time-frequency version for the non-zero order HOA coefficients with a sign of the sign count.

8. The device of claim 1, wherein the one or more processors are configured to:
determine a sign count based on a sign associated with each bin in a time-frequency band of a time-frequency version of the non-zero order HOA coefficients; and
when an absolute value of the sign count exceeds a sign threshold and the sign count has a positive sign, generate the sign information to associate the time-frequency band of the time-frequency version for the non-zero order HOA coefficients with a positive sign.

9. The device of claim 1, wherein the one or more processors are configured to:
determine a sign count based on a sign associated with each bin in a time-frequency band of a time-frequency version of the non-zero order HOA coefficients; and
when an absolute value of the sign count exceeds a sign threshold and the sign count has a negative sign, generate the sign information to associate the time-frequency band of the time-frequency version for the non-zero order HOA coefficients with a negative sign.

10. The device of claim 1, wherein the one or more processors are configured to:
determine a sign count based on a sign associated with each bin in a time-frequency band of a time-frequency version of the non-zero order HOA coefficients, and when an absolute value of the sign count does not exceed a sign threshold; and
generate the sign information to associate the time-frequency band of the time-frequency version for the non-zero order HOA coefficients of a current frame with sign information generated to associate a corresponding time-frequency band of the time-frequency version of the non-zero order HOA coefficients of a previous frame.

11. The device of claim 1, further comprising:
a speaker configured to playback audio data indicative of the non-zero order HOA coefficients and the zero-order HOA coefficients.

12. A method of encoding audio data, the method comprising:
obtaining spatial information for a spatial relation of:
non-zero order higher-order ambisonic (HOA) coefficients associated with a spherical basis function having an order greater than zero, with
zero-order HOA coefficients associated with a spherical basis function having an order of zero,
the spatial information resulting in an error between the non-zero order HOA coefficients and a signal model of the non-zero order HOA coefficients that represents at least one directional component of the non-zero order HOA coefficients in the spatial relation with the zero-order HOA coefficients; and
obtaining sign information for the non-zero order HOA coefficients when reconstructing the non-zero order HOA coefficients using the spatial relation.

13. The method of claim 12,
wherein the non-zero order HOA coefficients comprise an X signal, a Y signal, and a Z signal, each of the X signal, Y signal, and Y signal comprising values for a plurality of frequency bins at a time,
wherein the zero-order HOA coefficients comprise a W signal, the W signal comprising values for a plurality of frequency bins at the time, the method further comprising:
mixing one or more of a quantized version of the X signal, a quantized version of the Y signal and a quantized version of the Z signal with a quantized version of the W signal.

14. The method of claim 13, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:
\hat{X}=\sqrt{a}*\hat{X}+\sqrt{1−a}*\hat{W};
Ŷ=\sqrt{a}*Ŷ+\sqrt{1−a}*\hat{W};
\hat{Z}=\sqrt{a}*\hat{Z}+\sqrt{1−a}*\hat{W},
where ‘a’ denotes a weight.

15. The method of claim 13, wherein mixing the one or more of the quantized version of the X signal, \hat{X}, the quantized version of the Y signal, Ŷ, and the quantized version of the Z signal, \hat{Z}, with the quantized version of the W signal, Ŵ, comprises mixing the quantized version of the X signal, \hat{X}, the quantized version of the Y signal, Ŷ, and the quantized version of the Z signal, \hat{Z}, with the quantized version of the W signal, Ŵ, in accordance with the following equations:
\hat{X}=a*\hat{X}+(1−a)*\hat{W};
Ŷ=a*Ŷ+(1−a)*\hat{W};
\hat{Z}=a*\hat{Z}+(1−a)*\hat{W},
where ‘a’ denotes a weight.

16. A device for decoding audio data, the device comprising:
a memory to store the audio data; and
one or more processors coupled to the memory and configured to obtain spatial information including an elevation angle and an azimuth angle for a spatial relation of:
one of a first plurality of hierarchical elements comprising at least one of an X signal, a Y signal, and a Z signal and associated with a basis function having an order greater than zero, with
a second plurality of hierarchical elements comprising a W signal and associated with a basis function having a zero order,
the spatial information resulting in an error between the first plurality of hierarchical elements and a signal model of the first plurality of hierarchical elements that represents at least one directional component of the first plurality of hierarchical elements in the spatial relation with the second plurality of hierarchical elements.

17. The device of claim 16,
wherein the first plurality of hierarchical elements comprises an X signal, a Y signal, and a Z signal, each of the X signal, Y signal, and Y signal comprising values for a plurality of frequency bins at a time, and
wherein the second plurality of hierarchical elements comprises a W signal, the W signal comprising values for a plurality of frequency bins at the time.

18. The device of claim 17, wherein the one or more processors are further configured to determine an azimuth angle, θ, of the spatial information according to:
$$sin {θ}_{i} = \frac{{Σ}_{k = B ( i )}^{B ( i + 1 )} {W}_{k} {Y}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2}}}$$
wherein k represents a frequency bin of the plurality of frequency bins of an i^{th} frequency band B.

19. The device of claim 17, wherein the one or more processors are further configured to determine an elevation angle, φ, of the spatial information according to:
$$in {ϕ}_{i} = \frac{{Σ}_{k = B ( i )}^{B ( i + 1 )} {W}_{k} {Z}_{k}}{\sqrt{{( {Σ}_{k = B ( i )}^{B ( i + 1 )} {W}_{k} {X}_{k} )}^{2} + {( {Σ}_{k = B ( i )}^{B ( i + 1 )} {W}_{k} {Y}_{k} )}^{2} + {( {Σ}_{k = B ( i )}^{B ( i + 1 )} {W}_{k} {Z}_{k} )}^{2}}}$$
wherein k represents a frequency bin of the plurality of frequency bins of an i^{th} frequency band B.

20. The device of claim 16,
wherein the second plurality of hierarchical elements comprises values for a plurality of frequency bins at each of a plurality of time samples,
wherein the one or more processors are further configured to delta code the spatial information by the plurality of time samples.

21. The device of claim 16, wherein to delta code the spatial information the one or more processors are further configured to allocate a larger number of bits for higher-frequency frequency bands than for lower-frequency bands.

22. The device of claim 16,
wherein the first plurality of hierarchical elements associated with a basis function having an order greater than zero comprise a first plurality of HOA coefficients,
wherein the second plurality of hierarchical elements associated with a basis function having a zero order comprise a second plurality of HOA coefficients, and
wherein the basis function having the order greater than zero and the basis function having the zero order are spherical basis functions.

23. The device of claim 16, the one or more processors further configured to:
retrieve a bitstream that includes encoded audio data comprising the second plurality of hierarchical elements and the spatial information;
parse the encoded audio data from the bitstream to obtain the spatial information; and
decode the parsed encoded audio data to obtain the second plurality of hierarchical elements.

24. The device of claim 16, the one or more processors further configured to:
retrieve a bitstream that includes encoded audio data and the spatial information;
parse the encoded audio data from the bitstream,
wherein to obtain the spatial information the one or more processors parse the spatial information from the bitstream; and
decode the parsed encoded audio data in accordance with an audio coding scheme and the spatial information to obtain a quantized version of the first plurality of hierarchical elements.

25. The device of claim 16, further comprising:
at least one microphone configured to capture audio data indicative of the first plurality of hierarchical elements and the second plurality of hierarchical elements.

26. A method of encoding audio data, the method comprising:
obtaining spatial information including an elevation angle and an azimuth angle for a spatial relation of:
one of a first plurality of hierarchical elements comprising at least one of an X signal, a Y signal, and a Z signal and associated with a basis function having an order greater than zero, with
a second plurality of hierarchical elements comprising a W signal and associated with a basis function having a zero order,
the spatial information resulting in an error between the first plurality of hierarchical elements and a signal model of the first plurality of hierarchical elements that represents at least one directional component of the first plurality of hierarchical elements in the spatial relation with the second plurality of hierarchical elements.

27. The method of claim 26,
wherein the first plurality of hierarchical elements comprises an X signal, a Y signal, and a Z signal, each of the X signal, Y signal, and Y signal comprising values for a plurality of frequency bins at a time, and
wherein the second plurality of hierarchical elements comprises a W signal, the W signal comprising values for a plurality of frequency bins at the time.

28. The method of claim 26, wherein the second plurality of hierarchical elements comprises values for a plurality of frequency bins at each of a plurality of time samples, the method further comprising:
delta coding the spatial information by the plurality of time samples.
